(19) United States
(12) Patent Application Publication
(10) Pub. No.: US 2012/0172830 A1
(43) Pub. Date: Jul. 5, 2012

(54) MIXING APPARATUS AND PIERCING METHOD FOR A DOUBLE-ENDED NEEDLE

(75) Inventors: Kenji Yokoyama, Ashigarakami-gun (JP); Akira Sawada, Fujinomiya-shi (JP)

(73) Assignee: TERUMO KABUSHIKI KAISHA, Tokyo (JP)

(21) Appl. No.: 13/394,678

(22) PCT Filed: Sep. 8, 2010
(86) PCT No.: PCT/JP2010/065405

§ 371 Date: Mar. 7, 2012

(30) Foreign Application Priority Data
Sep. 8, 2009 (JP) 2009-207382
Sep. 8, 2009 (JP) 2009-207384

(51) Int. Cl. A61J 1/20

(52) U.S. Cl. 604/413

(57) ABSTRACT

A mixing apparatus for mixing a first component and a second component comprises: a first vessel which has a negative internal pressure and houses the first component; a second vessel which houses the second component; and a double-ended needle which allows communication between the first vessel and the second vessel when a first stopper element and a second stopper element have been pierced through by the needle. Penetration-resistance increasing parts which have a greater penetration resistance with respect to the first stopper element and the second stopper element than tip end tubes are respectively provided on a first puncture needle and a second puncture needle of the double-ended needle at positions further towards the base end than the tip end tubes. The axial heights of the edge faces of the tip end tubes are both less than the thicknesses of the first stopper element and of the second stopper element.

### TECHNICAL FIELD

The present invention relates to a mixing instrument (apparatus) for mixing a first component in a solid phase or a liquid phase and a second component in a liquid phase with each other. The present invention also relates to a piercing method for a double-ended needle.

### BACKGROUND ART

Heretofore, in a medical organization or the like, when a patient is to be given an intravenous drip injection (for transfusion), an adhesion preventive, or a living tissue adhesive or the like, it often is customary to prepare a drug solution by diluting or dissolving a drug within a liquid, and then to draw the drug solution into a syringe. To produce such a drug solution, a device with a double-ended needle is used. More specifically, a plug (rubber plug) on a drug container which contains a drug in a solid phase or a liquid phase, and which has a negative pressure developed therein, is pierced with one end of the double-ended needle to connect the drug container to the double-ended needle, and a plug on a liquid container, which contains a liquid such as distilled water or the like, is pierced with the other end of the double-ended needle to connect the liquid container to the double-ended needle, thereby bringing the drug container and the liquid container into fluid communication with each other through the double-ended needle. Since a negative pressure is developed in the drug container, the liquid in the liquid container is attracted to and flows into the drug container via the double-ended needle. Thereafter, the drug container is shaken several times. The drug in the drug container becomes diluted and is dissolved by the liquid that has flowed into the drug container.

Background art, which is concerned with a device for mixing a drug and a liquid using a double-ended needle, is disclosed in Japanese Laid-Open Patent Publication No. 2008-523851 (PCT) and Japanese Laid-Open Patent Publication No. 2001-333961, for example.

### SUMMARY OF INVENTION

When the double-ended needle is connected to the drug container and the liquid container, if the piercing point of the double-ended needle for the drug container is inserted through the plug on the drug container before the piercing point of the double-ended needle for the liquid container is inserted through the plug on the liquid container, then the negative pressure in the drug container is eliminated, making it impossible to attract the liquid from the liquid container. Conversely, if the piercing point of the double-ended needle for the liquid container is inserted through the plug on the liquid container before the piercing point of the double-ended needle for the drug container is inserted through the plug on the drug container, then the liquid tends to unduly leak from the liquid container. Consequently, the amount of liquid that flows into the drug container tends to change, and a proper amount of liquid to be mixed with the drug cannot be made available.

Therefore, the mixing instruments according to the background art are liable to cause a handling error by eliminating the negative pressure in the drug container or by allowing liquid to leak from the liquid container, unless the timing at which the piercing point of the double-ended needle for the drug container is inserted through the plug on the drug container is the same as the timing at which the piercing point of the double-ended needle for the liquid container is inserted through the plug on the liquid container. The above two timings may be brought into conformity with each other by increasing the speed at which the double-ended needle is inserted into the drug container and the liquid container. However, such an approach is difficult to apply if the double-ended needle is handled by persons who are not sufficiently skilled or physically strong enough.

The present invention has been made in view of the above problems. It is an object of the present invention to provide a mixing instrument, which can be handled easily without causing handling errors, by maintaining a negative pressure in a drug container and preventing liquid from leaking from a liquid container, even if the timing at which a puncture needle for the drug container of a double-ended needle penetrates a plug on the drug container differs from the timing at which a puncture needle for the liquid container of the double-ended needle penetrates a plug on the liquid container. Another object of the present invention is to provide a piercing method for a double-ended needle.

To achieve the above objects, there is provided in accordance with the present invention a mixing instrument for mixing a first component and a second component with each other, comprising a first container for storing the first component, the first container having a mouth sealed by a first plug made of an elastic material and having a negative pressure developed therein, a second container for storing the second component, the second container having a mouth sealed by a second plug made of an elastic material, and a double-ended needle having a first puncture needle for piercing the first plug and a second puncture needle for piercing the second plug, wherein the double-ended needle brings the first container and the second container into fluid communication with each other when the first puncture needle pierces the first plug and the second puncture needle pierces the second plug, wherein the first puncture needle and the second puncture needle include respective increased penetration resistance members disposed at positions closer to proximal end portions than distal-end tubes thereof including cutting faces, and having a greater penetration resistance to the first plug and the second plug than the distal-end tubes, and wherein the cutting faces of the distal-end tubes have respective heights in an axial direction which are smaller than thicknesses of the first plug and the second plug.

With the above arrangement of the present invention, the first puncture needle and the second puncture needle have respective distal-end tubes with openings formed in the cutting faces on distal ends thereof, and the respective increased penetration resistance members, which are disposed at positions closer to the proximal end portions than the distal-end tubes thereof, and having a greater penetration resistance to the first plug and the second plugs than the distal-end tubes. When the double-ended needle is connected to the first container and the second container, the distal-end tubes, including needle points with a relatively small penetration resistance, are initially inserted into the rubber plugs, and then, the increased penetration resistance members with a relatively large penetration resistance are inserted into the rubber plugs. After the openings in the needle points of the first puncture needle and the second puncture needle have been closed respectively by the first plug and the second plug, the first puncture needle and the second puncture needle penetrate the first plug and the second plug, respectively. Consequently, the negative pressure in the drug container is maintained and liquid is prevented from leaking out, even if the timing at which the first puncture needle penetrates the first plug differs from the timing at which the second puncture needle penetrates the second plug. More specifically, even if the first puncture needle penetrates the first plug before the second puncture needle penetrates the second plug, since the opening in the distal end of the second puncture needle is closed by the second plug, the negative pressure in the drug container is maintained. Further, even if the second puncture needle penetrates the second plug before the first puncture needle penetrates the first plug, since the opening in the distal end of the first puncture needle is closed by the first plug, liquid is prevented from leaking out. According to the present invention, since the negative pressure in the first container is maintained and liquid is prevented from leaking out, even if the timing at which the first puncture needle penetrates the first plug differs from the timing at which the second puncture needle penetrates the second plug, a mixing instrument is provided which can be handled easily without causing handling errors.

In the above mixing instrument, the increased penetration resistance members comprise increased diameter members having outside diameters greater than the outside diameters of the distal-end tubes.

With the above arrangement, since the increased penetration resistance members comprise the increased diameter members, respectively, having an outside diameter greater than the outside diameter of the distal-end tubes, the penetration resistance is increased with a simple arrangement by a step provided by the different outside diameters of the distal-end tubes and the increased diameter members.

In the above mixing instrument, the first puncture needle and the second puncture needle have respective inner tubes made of metal and including the distal-end tubes and respective outer tubes surrounding the inner tubes that serve as the increased penetration resistance members.

With the above arrangement, since the distal-end tubes including the cutting edges are made of metal, the cutting edges can easily be formed as sharp edges. The cutting edges, which are formed as sharp edges, reduce the penetration resistance of the distal-end tubes with respect to the first plug and the second plug, thereby reducing the forces required to cause the distal-end tubes to pierce the first plug and the second plug. The mixing instrument can thus be handled more easily.

The above mixing instrument further comprises a first holder shaped as a hollow tube having a first opening formed in an end thereof, the first container being mounted in the first holder, a second holder shaped as a hollow tube having a second opening formed in an end thereof, the second container being mounted in the second holder, and a connector, the double-ended needle being mounted on the connector, the connector being slidable in an axial direction of the double-ended needle into fitting engagement with the end of the first holder with the first container insertion opening formed therein, and being slidable in an axial direction of the double-ended needle into fitting engagement with the end of the second holder with the second container insertion opening formed therein.

With the above arrangement, the first holder with the first container mounted therein and with the first plug positioned near the first opening, and the connector with the first puncture needle oriented toward the first plug are slid axially into fitting engagement with each other. Further, the second holder with the second container mounted therein and with the second plug positioned near the second opening, and the connector with the second puncture needle oriented toward the second plug are slid axially into fitting engagement with each other. The first puncture needle thus pierces the first plug, while the second puncture needle pierces the second plug. When the first holder, the connector, and the second holder are fitted together, they slide against each other and are guided in relative axial movement. Therefore, the first puncture needle and the second puncture needle can pierce the first plug and the second plug, respectively, accurately and simply in the axial direction, whereby the mixing instrument can be handled more easily.

The above mixing instrument further comprises a lock mechanism for releasably locking the first holder, the connector, and the second holder inseparably together when the first holder, the connector, and the second holder are fitted together in a relative positional relation, such that the first puncture needle pierces the first plug and the second puncture needle pierces the second plug.

With the above arrangement, when the first holder, the connector, and the second holder are coupled together, they are locked by the lock mechanism so that they can be handled in their entirety as an integrated mixing instrument. Consequently, it is easy to perform the process of shaking the mixing instrument in order to accelerate mixing of the first component and the second component.

In the above mixing instrument, the first container, the second container, and the double-ended needle each are provided in two sets, two first containers are mounted in the first holder, two second containers are mounted in the second holder, paired double-ended needles are mounted on the connector and spaced from each other in directions perpendicular to the axial direction, and one of the double-ended needles and the other double-ended needle have respective cutting faces facing away from each other in directions in which the double-ended needles are spaced from each other.

With the above arrangement, when the paired double-ended needles pierce the first plug and the second plug, respectively, forces acting horizontally on the double-ended needles cancel each other out. Therefore, the sliding resistance between the first holder, the connector, and the second holder is prevented from increasing when such elements are fitted together. Since resistive forces are prevented from unduly increasing at the time that the first holder, the connector, and the second holder are coupled together, the mixing instrument can be handled with greater ease.

According to the present invention, there also is provided a piercing method for causing a double-ended needle, having a first puncture needle on one end and a second puncture needle on another end thereof, to pierce a first plug made of an elastic material and sealing a mouth of a first container and a second plug made of an elastic material and sealing a mouth of a second container having a negative pressure developed therein, thereby bringing the first container and the second container into fluid communication with each other, comprising the steps of preparing the double-ended needle having the first puncture needle and the second puncture needle which include respective increased penetration resistance members disposed at positions closer to proximal end portions than distal-end tubes thereof including cutting faces, and having a greater penetration resistance to the first plug and the second plug than the distal-end tubes, sealing both ends by pressing a distal end of the first puncture needle into the first plug to close a first opening formed in the distal end of the first puncture needle with the first plug while temporarily preventing a distance by which the first puncture needle is inserted into the first plug from increasing with the increased penetration resistance member of the first puncture needle, and pressing a distal end of the second puncture needle into the second plug to close a second opening formed in the distal end of the second puncture needle while temporarily preventing a distance by which the second puncture needle is inserted into the second plug from increasing with the increased penetration resistance member of the second puncture needle, and after sealing both ends, piercing the first plug with the first puncture needle and piercing the second plug with the second puncture needle to thereby bring the first container and the second container into fluid communication with each other.

With the above piercing method for the double-ended needle according to the present invention, the negative pressure in the drug container is maintained and the liquid is prevented from leaking out, even if the timing at which the first puncture needle penetrates the first plug differs from the timing at which the second puncture needle penetrates the second plug. More specifically, even if the first puncture needle penetrates the first plug before the second puncture needle penetrates the second plug, since the opening in the distal end of the second puncture needle is closed by the second plug, negative pressure in the drug container is maintained. Further, even if the second puncture needle penetrates the second plug before the first puncture needle penetrates the first plug, since the opening in the distal end of the first puncture needle is closed by the first plug, liquid is prevented from leaking out. According to the present invention, therefore, the plugs can be pierced by the double-ended needle simply without handling errors, by maintaining the negative pressure in the first container and preventing liquid from leaking out, even if the timing at which the first puncture needle penetrates the first plug differs from the timing at which the second puncture needle penetrates the second plug.

According to the present invention, there also is provided a mixing instrument for mixing a first component and a second component with each other, comprising a first container for storing the first component, the first container being sealed by a first plug made of an elastic material and having a negative pressure developed therein, a second container for storing the second component, the second container having a mouth sealed by a second plug made of an elastic material, and a double-ended needle having a first puncture needle for piercing the first plug and a second puncture needle for piercing the second plug, wherein the double-ended needle brings the first container and the second container into fluid communication with each other when the first puncture needle pierces the first plug and the second puncture needle pierces the second plug, wherein respective needle point angles of the first puncture needle and the second puncture needle and respective elastic characteristics of the first plug and the second plug are established, such that when the first puncture needle is pressed by the first plug and the second puncture needle is pressed by the second plug, openings formed in opposite ends of a lumen of the double-ended needle are sealed by the first plug and the second plug, respectively, and wherein the first puncture needle and the second puncture needle have respective cutting faces having respective heights in an axial direction which are smaller than thicknesses of the first plug and the second plug.

With the above arrangement according to the present invention, since the needle point angles of the first puncture needle and the second puncture needle and the elastic characteristics of the first plug and the second plug are established in the foregoing manner, when the double-ended needle pierces the first plug and the second plug, the first plug pressed by the first puncture needle and the second plug pressed by the second puncture needle are initially elastically deformed, and openings in opposite ends of the lumen are simultaneously sealed before the first puncture needle and the second puncture needle penetrate through the first plug and the second plug, respectively. Therefore, even if the timing at which the first puncture needle penetrates the first plug differs from the timing at which the second puncture needle penetrates the second plug, negative pressure in the drug container is maintained and liquid is prevented from leaking out. More specifically, even if the first puncture needle penetrates the first plug before the second puncture needle penetrates the second plug, since the opening of the lumen of the second puncture needle is sealed by the second plug, negative pressure in the drug container is maintained. Further, even if the second puncture needle penetrates the second plug before the first puncture needle penetrates the first plug, since the opening of the lumen of the first puncture needle is sealed by the first plug, liquid is prevented from leaking out. According to the present invention, therefore, even if the timing at which the first puncture needle penetrates the first plug of the drug container differs from the timing at which the second puncture needle penetrates the second plug of the liquid container, negative pressure in the drug container is maintained and liquid is prevented from leaking out. Accordingly, a mixing instrument is provided, which can be handled easily without causing handling errors.

In the above mixing instrument, the cutting faces of the first puncture needle and the second puncture needle are shaped as concave surfaces, which are curved as viewed in vertical cross section, and a point of intersection between a line segment that extends between a proximal end portion of each of the cutting faces and a distal end portion thereof, and a line normal to the line segment that extends from a deepest point on the concave surface is positioned closer to the proximal end portion of the cutting face than the midpoint of the line segment, and a center of the lumen is closer to the proximal end portion of the cutting face than a central line of each puncture needle.

With the above arrangement, the proximal end areas of the cutting faces, which are formed as concave surfaces, of the first puncture needle and the second puncture needle function as chins. Since such chins increase the penetration resistance by which the first plug and the second plug are penetrated, when the distal ends of the first puncture needle and the second puncture needle bite into the first plug and the second plug, the chins temporarily bear the first plug and the second plug. Since the openings of the lumen are positioned closer to the proximal end portions (the chins) of the cutting faces than the central line of the needle, while the chins bear the first plug and the second plug, the openings in opposite ends of the lumen are simultaneously sealed by the first plug and the second plug.

The above mixing instrument further comprises a first holder shaped as a hollow tube having a first opening formed in one end thereof, the first container being mounted in the first holder, a second holder shaped as a hollow tube having a second opening formed in one end thereof, the second container being mounted in the second holder, and a connector, the double-ended needle being mounted on the connector, the connector being slidable in an axial direction of the double-ended needle into fitting engagement with the end of the first holder with the first container insertion opening formed therein, and being slidable in an axial direction of the double-ended needle into fitting engagement with the end of the second holder with the second container insertion opening formed therein.

With the above arrangement, the first holder with the first container mounted therein and with the first plug positioned near the first opening, and the connector with the first puncture needle oriented toward the first plug are slid axially into fitting engagement with each other. Also, the second holder with the second container mounted therein and with the second plug positioned near the second opening, and the connector with the second puncture needle oriented toward the second plug are slid axially into fitting engagement with each other. Therefore, the first puncture needle pierces the first plug and the second puncture needle pierces the second plug. When the first holder, the connector, and the second holder are fitted together, such elements slide against each other and are guided for relative axial movement. Therefore, the first puncture needle and the second puncture needle can pierce the first plug and the second plug, respectively, accurately and simply in the axial direction. Consequently, the mixing instrument can be handled more easily.

The above mixing instrument further comprises a lock mechanism for releasably locking the first holder, the connector, and the second holder inseparably together when the first holder, the connector, and the second holder are fitted together in a relative positional relation, such that the first puncture needle pierces the first plug and the second puncture needle pierces the second plug.

With the above arrangement, when the first holder, the connector, and the second holder are coupled together, the components are locked by the lock mechanism so that they can be handled in their entirety as an integrated mixing instrument. Consequently, it is easy to perform the process of shaking the mixing instrument to accelerate mixing of the first component and the second component.

In the above mixing instrument, the first container, the second container, and the double-ended needle each are provided in two sets, such that two first containers are mounted in the first holder, two second containers are mounted in the second holder, the paired puncture needles are mounted on the connector and spaced from each other in directions perpendicular to the axial direction, and one of the double-ended needles and the other double-ended needle have respective cutting faces facing away from each other in directions in which the double-ended needles are spaced from each other.

With the above arrangement, when the paired double-ended needles pierce the first plug and the second plug, respectively, horizontal forces acting on the double-ended needles cancel each other out. Therefore, sliding resistance between the first holder, the connector, and the second holder is prevented from increasing when the components are fitted together. Since resistive forces are prevented from unduly increasing at the time that the first holder, the connector, and the second holder are coupled together, the mixing instrument can be handled with greater ease.

According to the present invention, there is further provided a piercing method for causing a double-ended needle, having a first puncture needle on one end and a second puncture needle on another end thereof, to pierce a first plug made of an elastic material and sealing a mouth of a first container, and a second plug made of an elastic material and sealing a mouth of a second container having a negative pressure developed therein, thereby bringing the first container and the second container into fluid communication with each other. The method comprises the steps of preparing the double-ended needle, the first plug, and the second plug, wherein respective needle point angles of the first puncture needle and the second puncture needle and respective elastic characteristics of the first plug and the second plug are established, such that when the first puncture needle is pressed by the first plug and the second puncture needle is pressed by the second plug, openings formed in opposite ends of a lumen of the double-ended needle are sealed by the first plug and the second plug, respectively, sealing both ends by pressing a distal end of the first puncture needle into the first plug to elastically deform the first plug and to close a first opening formed in the distal end of the first puncture needle with the first plug, and pressing a distal end of the second puncture needle into the second plug to elastically deform the second plug and to close a second opening formed in the distal end of the second puncture needle with the second plug, and after sealing both ends, piercing the first plug with the first puncture needle and piercing the second plug with the second puncture needle to thereby bring the first container and the second container into fluid communication with each other.

With the above piercing method for a double-ended needle according to the present invention, the negative pressure in the drug container is maintained and the liquid is prevented from leaking out, even if the timing at which the first puncture needle penetrates the first plug differs from the timing at which the second puncture needle penetrates the second plug. More specifically, even if the first puncture needle penetrates the first plug before the second puncture needle penetrates the second plug, since the opening in the distal end of the second puncture needle is closed by the second plug, negative pressure in the drug container is maintained. Further, even if the second puncture needle penetrates the second plug before the first puncture needle penetrates the first plug, since the opening in the distal end of the first puncture needle is closed by the first plug, liquid is prevented from leaking out. According to the present invention, therefore, the plugs can be pierced by the double-ended needle simply and without handling errors by maintaining the negative pressure in the first container and preventing the liquid from leaking out, even if the timing at which the first puncture needle penetrates the first plug differs from the timing at which the second puncture needle penetrates the second plug.

According to the present invention, the mixing instrument can be handled easily without causing handling errors by maintaining the negative pressure in the drug container and by preventing liquid from leaking out, even if the timing at which the puncture needle for the drug container of the double-ended needle penetrates the plug on the drug container differs from the timing at which the puncture needle for the liquid container of the double-ended needle penetrates the plug on the liquid container.

According to the present invention, the piercing method for the double-ended needle allows the double-ended needle to pierce the plugs simply without causing handling errors.

### BRIEF DESCRIPTION OF DRAWINGS

FIG. 1 is a cross-sectional view of a mixing instrument according to a first embodiment of the present invention;

FIG. 2A is an enlarged cross-sectional view, partially omitted from illustration, showing a lock mechanism in a first state;

FIG. 2B is an enlarged cross-sectional view, partially omitted from illustration, showing the lock mechanism in a second state;

FIG. 3 is an enlarged cross-sectional view, partially omitted from illustration, showing a double-ended needle and nearby parts of the mixing instrument according to the first embodiment of the present invention;

FIG. 4 is an enlarged cross-sectional view, partially omitted from illustration, illustrative of dimensions of a distal end portion of the double-ended needle of the mixing instrument according to the first embodiment of the present invention;

FIG. 5 is a cross-sectional view showing the manner in which the double-ended needle of the mixing instrument according to the first embodiment of the present invention has distal-end tubes thereof inserted into a first plug and a second plug;

FIG. 6 is an enlarged cross-sectional view, partially omitted from illustration, showing the manner in which the double-ended needle of the mixing instrument according to the first embodiment of the present invention has one of the distal-end tubes thereof inserted into the first plug;

FIG. 7 is a cross-sectional view showing the manner in which the double-ended needle of the mixing instrument according to the first embodiment of the present invention extends through the first plug and the second plug, thereby bringing a first container and a second container into fluid communication with each other;

FIG. 8A is an enlarged cross-sectional view, partially omitted from illustration, showing a first modification of the double-ended needle of the mixing instrument according to the first embodiment of the present invention;

FIG. 8B is an enlarged cross-sectional view, partially omitted from illustration, showing a second modification of the double-ended needle of the mixing instrument according to the first embodiment of the present invention;

FIG. 9 is an exploded perspective view of a mixing instrument according to a second embodiment of the present invention;

FIG. 10 is a cross-sectional view of the mixing instrument according to the second embodiment of the present invention;

FIG. 11 is a cross-sectional view showing the manner in which double-ended needles of the mixing instrument according to the second embodiment of the present invention have distal-end tubes thereof inserted into first plugs and second plugs;

FIG. 12 is a cross-sectional view showing the manner in which the double-ended needles of the mixing instrument according to the second embodiment of the present invention extend through the first plugs and the second plugs, thereby bringing first containers and second containers into fluid communication with each other;

FIG. 13 is a cross-sectional view of a mixing instrument according to a third embodiment of the present invention;

FIG. 14 is an enlarged cross-sectional view, partially omitted from illustration, showing a double-ended needle and nearby parts of the mixing instrument according to the third embodiment of the present invention;

FIG. 15 is an enlarged cross-sectional view, partially omitted from illustration, showing a first puncture needle and nearby parts of the mixing instrument according to the third embodiment of the present invention;

FIG. 16 is a cross-sectional view showing the manner in which the double-ended needle of the mixing instrument according to the third embodiment of the present invention pierces a first plug and a second plug;

FIG. 17 is an enlarged cross-sectional view, partially omitted from illustration, showing the manner in which a lumen of the first puncture needle of the mixing instrument according to the third embodiment of the present invention is sealed by the first plug;

FIG. 18 is a cross-sectional view showing the manner in which the double-ended needle of the mixing instrument according to the third embodiment of the present invention extends through the first plug and the second plug, thereby bringing a first container and a second container into fluid communication with each other;

FIG. 19 is an exploded perspective view of a mixing instrument according to a fourth embodiment of the present invention;

FIG. 20 is a cross-sectional view of the mixing instrument according to the fourth embodiment of the present invention;

FIG. 21 is an enlarged cross-sectional view, partially omitted from illustration, showing a pair of double-ended needles and nearby parts of the mixing instrument according to the fourth embodiment of the present invention;

FIG. 22 is a cross-sectional view showing the manner in which the double-ended needles of the mixing instrument according to the fourth embodiment of the present invention pierce first plugs and second plugs; and

FIG. 23 is a cross-sectional view showing the manner in which the double-ended needles of the mixing instrument according to the fourth embodiment of the present invention extend through the first plugs and the second plugs, thereby bringing first containers and second containers into fluid communication with each other.

### DESCRIPTION OF EMBODIMENTS

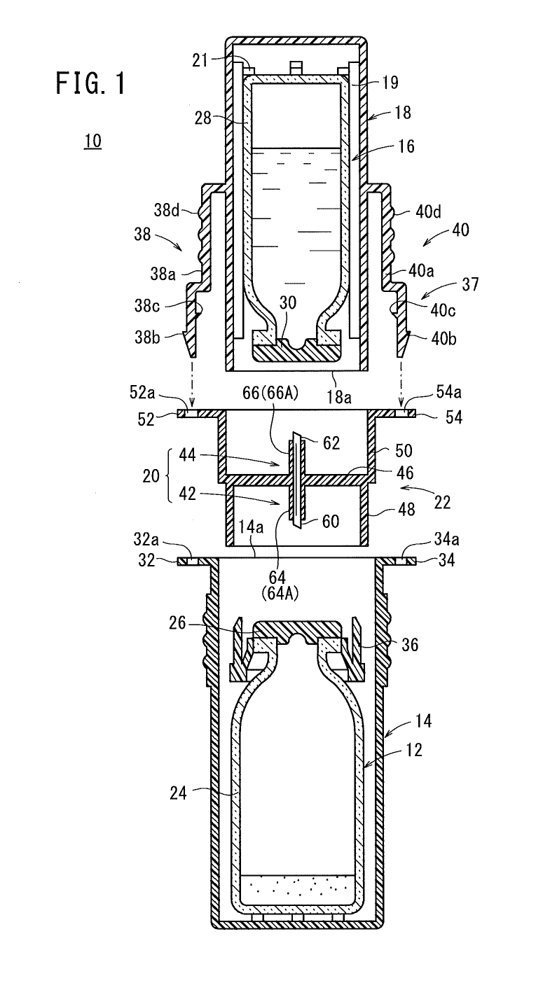

Embodiments of the present invention will hereinafter be described below with reference to the drawings. For illustrative purposes, the upper side, the lower side, the left side, and the right side in FIGS. 1 to 12 will be referred to as “upper,” “lower,” “left,” and “right” sides respectively.

### First Embodiment

FIG. 1 is a cross-sectional view of a mixing instrument 10 according to a first embodiment of the present invention. The mixing instrument 10 serves to mix a first component in a solid phase or a liquid phase, and a second component in a liquid phase. Although the first component is illustrated as being in a solid phase or a liquid phase, whereas the second component is illustrated as being in a liquid phase, the components are not limited to such states. The first component may be in a gel state or a gaseous state. Similarly, the second component may be in a gel state or a gaseous state.

As shown in FIG. 1, the mixing instrument 10 includes a drug container (first container) 12 for storing the first component therein, a drug holder (first holder) 14 for mounting the drug container 12 thereon, a liquid container (second container) 16 for storing the second component therein, a liquid holder (second holder) 18 for mounting the liquid container 16 thereon, a double-ended needle 20 for bringing the drug container 12 and the liquid container 16 into fluid communication with each other, and a connector 22 to which the double-ended needle 20 is fixed.

The drug container 12 and the liquid container 16 are not limited to any particular type of container, but may be vials or the like.

The drug container 12 stores a drug as the first component. The drug is not limited to any particular form, but may be a solid (tablets, granules, etc.), a powder (powder medicine, etc.), or a liquid (liquid medicine, etc.). If a living tissue adhesive is to be prepared, then the drug may be thrombin or fibrinogen. If an adhesion preventive is to be prepared, then the drug may be carboxymethyl dextrin produced by modifying a drug with a succinimidyl group, for example, or a mixture of sodium hydrogen carbonate and sodium carbonate. The drug container 12 has a negative pressure developed therein.

The liquid container 16 stores a liquid as the second component. The second component is a liquid such as distilled water or the like, for example, which dilutes or dissolve the drug that makes up the second component.

As shown in FIG. 1, the drug container 12 includes a hard container body 24 and a first plug 26 made of an elastic material, which hermetically seals the mouth of the container body 24. The liquid container 16 includes a hard container body 28 and a second plug 30 made of an elastic material, which hermetically seals the mouth of the container body 28.

The container bodies 24, 28 are made of a material, which is not limited to any particular material, but which may be any of various glasses or various resins, such as polyvinyl chloride, polyethylene, polypropylene, cyclic polyolefin, polystyrene, poly-(4-methylpentene-1), polycarbonate, acrylic resin, an acrylonitrile-butadiene-styrene copolymer, a polyester such as polyethylene terephthalate, polyethylene naphthalate, or the like, a butadiene-styrene copolymer, and polyamide (e.g., nylon 6, nylon 6·6, nylon 6·10, or nylon 12). Resins are preferable to glasses. If the container bodies 24, 28 are made of a resin, then the container bodies 24, 28 can be discarded by burning and hence the process of discarding the container bodies 24, 28 can be minimized. The container bodies 24, 28 should preferably be permeable to light (virtually transparent or translucent) for keeping the interior thereof visible.

The first plug 26 and the second plug 30 can be pierced by a first puncture needle 42 and a second puncture needle 44, to be described later. The first plug 26 and the second plug 30 are made of a material, which is not limited to any particular material, but which may be any of various rubber materials, such as natural rubber, butyl rubber, isoprene rubber, butadiene rubber, styrene-butadiene rubber, and silicone rubber, various thermoplastic elastomers such as a polyurethane thermoplastic elastomer, a polyester thermoplastic elastomer, a polyamide thermoplastic elastomer, an olefin thermoplastic elastomer, and a styrene thermoplastic elastomer, and elastic materials including mixtures of the aforementioned materials. If the first plug 26 and the second plug 30 are made of butyl rubber, then the rubber hardness thereof should preferably have a Shore A hardness in the range from 39 to 53°, and more preferably, in the range from 45 to 47°.

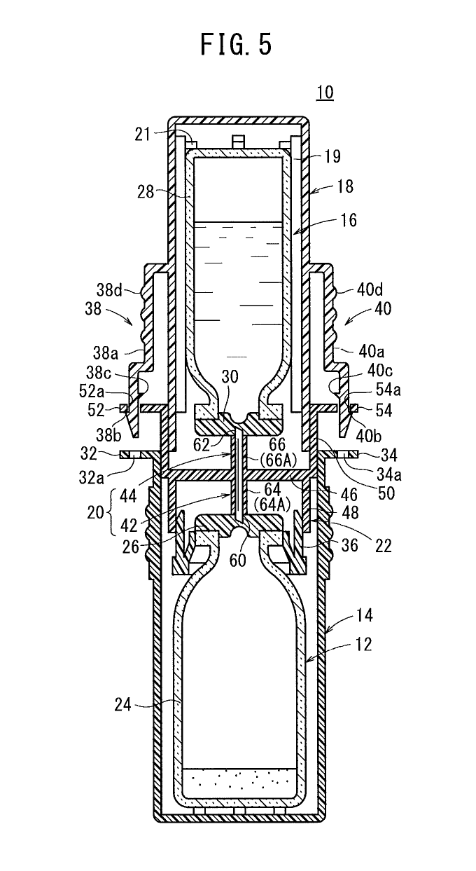

Portions of the first plug 26 and the second plug 30, which are pierced by the double-ended needle 20, have a thickness t (see FIG. 5), which preferably is in the range from 1 to 4 mm, and more preferably, in the range from 2.0 to 2.5 mm.

The drug holder 14 is a bottomed tubular component for storing the drug container 12 therein. The drug holder 14 is made of any of various resins, such as polyvinyl chloride, polyethylene, polypropylene, cyclic polyolefin, polystyrene, poly-(4-methylpentene-1), polycarbonate, acrylic resin, an acrylonitrile-butadiene-styrene copolymer, polyester such as polyethylene terephthalate, polyethylene naphthalate, or the like, a butadiene-styrene copolymer, and polyamide (e.g., nylon 6, nylon 6·6, nylon 6·10, or nylon 12).

The drug holder 14 has a first opening 14a formed in one end thereof. The drug container 12 is inserted into the drug holder 14 through the first opening 14a.

The drug holder 14 also has ledges 32, 34 that project horizontally outwardly from left and right sides of the upper end of the drug holder 14. The ledges 32, 34 have respective holes 32a, 34a formed vertically therethrough.

The drug holder 14 houses therein a restraint member 36 for restraining the drug container 12 with respect to the drug holder 14. The restraint member 36 has a tubular shape, which is open at upper and lower ends thereof. The restraint member 36 has protrusions (not shown) on the outer circumferential surface thereof, which engage in either recesses (not shown) formed in an inner circumferential surface of the drug holder 14, or holes (not shown) formed in a side wall of the drug holder 14, for thereby securing the drug container 12 at a predetermined position with respect to the drug holder 14.

The restraint member 36 may be made of materials, which are the same as the aforementioned materials of the drug holder 14.

The liquid holder 18 is a bottomed tubular component for storing the liquid container 16. As shown in FIG. 1, the liquid holder 18 has a side wall with a height large enough to fully house the liquid container 16 in the liquid holder 18.

The liquid holder 18 has a plurality of support guides 19 spaced circumferentially on an inner circumferential surface thereof for supporting the liquid container 16, and limiting projections 21 on the inner circumferential surface thereof for limiting the depth to which the liquid container 16 can be inserted.

The liquid holder 18 has a second opening 18a formed in an end thereof. The liquid container 16 is inserted into the liquid holder 18 through the second opening 18a.

The liquid holder 18 also includes a pair of lock members 38, 40 extending downwardly from left and right sides of an outer circumferential surface thereof. The lock members 38, 40 include respective arms 38a, 40a, first engaging portions 38b, 40b disposed on respective distal ends of the arms 38a, 40a, and second engaging portions 38c, 40c disposed on the arms 38a, 40a more closely to proximal ends thereof than the first engaging portions 38b, 40b. The arms 38a, 40a have a plurality of vertically spaced projections 38d, 40d, respectively, on outer side surfaces thereof.

As shown in FIG. 1, the double-ended needle 20 includes a first puncture needle 42 for piercing the first plug 26, and a second puncture needle 44 for piercing the second plug 30. The double-ended needle 20 is formed integrally with the connector 22.

The connector 22 has a partition 46 extending horizontally, a lower side wall 48 extending downwardly from the partition 46, and an upper side wall 50 extending upwardly from the partition 46. The first puncture needle 42 is mounted on the lower surface of the partition 46, and the second puncture needle 44 is mounted on the upper surface of the partition 46. The connector 22 may be made of materials, which are the same as the aforementioned materials of the drug holder 14.

The lower side wall 48 surrounds the first puncture needle 42. The lower side wall 48 has a height (vertical dimension) greater than the height of the first puncture needle 42, so that the distal end (cutting face) of the first puncture needle 42 does not project downwardly from the lower side wall 48.

The upper side wall 50 surrounds the second puncture needle 44 and has a shape and size such that the upper side wall 50 can be inserted into the drug container 12. The upper side wall 50 has a height greater than the height of the second puncture needle 44, so that the distal end (cutting face) of the second puncture needle 44 does not project upwardly from the upper side wall 50. The upper side wall 50 has ledges 52, 54 projecting horizontally outwardly from left and right sides of an upper end thereof. The ledges 52, 54 have respective holes 52a, 54a formed vertically therethrough.

The connector 22 can be inserted into the drug holder 14 with the outer circumferential surface of the upper side wall 50 serving as a sliding surface. More specifically, the connector 22 is capable of sliding longitudinally (vertically) along the double-ended needle 20 into fitting engagement with the drug holder 14.

The liquid holder 18 can be inserted into the connector 22 such that the outer circumferential surface of the lower end portion thereof serves as a sliding surface. More specifically, the liquid holder 18 can slide longitudinally along the double-ended needle 20 into fitting engagement with the connector 22.

According to the first embodiment, the lock members 38, 40, the ledges 32, 34, and the ledges 52, 54 jointly make up a lock mechanism 37. The lock mechanism 37 serves to releasably lock the drug holder 14, the connector 22, and the liquid holder 18 inseparably together when the drug holder 14, the connector 22, and the liquid holder 18 are fitted together in a relative positional relation, such that the first puncture needle 42 pierces the first plug 26 and the second puncture needle 44 pierces the second plug 30.

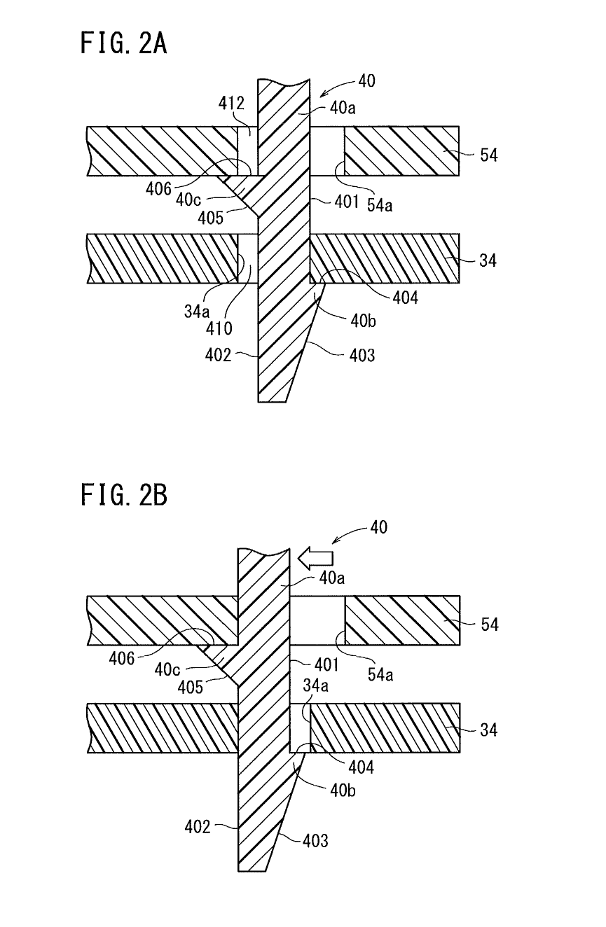

The lock mechanism 37 can selectively be placed in a first state, as shown in FIG. 2A, and a second state, as shown in FIG. 2B. In the first state, the liquid holder 18 engages the connector 22 and the drug holder 14 as a whole. In the second state, the liquid holder 18 engages the connector 22, but is disengaged from the drug holder 14.

Since the ledges 32, 34 of the drug holder 14 are identical in constitution, the right ledge 34 will typically be described below. Similarly, since the lock members 38, 40 and the ledges 52, 54 of the connector 22 are identical in constitution, the right lock member 40 and the right ledge 54 will typically be described below. Since the ledge 34, the lock member 40, and the ledge 54 are provided in respective pairs, the first state and the second state can be reliably achieved.

As shown in FIGS. 1, 2A and 2B, the lock member 40 includes a plate-like arm 40a projecting from the outer circumferential surface of the side wall of the liquid holder 18, a first engaging portion 40b projecting from one surface 401 of the arm 40a, and a second engaging portion 40c projecting from another surface 402 of the arm 40a.

The other surface 402 of the arm 40a faces toward the side wall of the liquid holder 18. The arm 40a has one end (an upper end as shown) supported on and fixed to the side wall of the liquid holder 18. Thus, the arm 40a is supported in a cantilevered fashion and can be elastically deformed when the arm 40a is pressed at a certain location on a floating portion thereof toward the side wall of the liquid holder 18. The arm 40a is of a crank shape as viewed in side elevation, or more specifically, the arm 40a is spaced from the side wall of the liquid holder 18 by a distance that increases stepwise toward the other end thereof (a lower end as shown).

As shown in FIGS. 2A and 2B, the first engaging portion 40b is constituted as a prong, which projects from the distal end of the arm 40a. The first engaging portion 40b has a slanted surface 403 inclined with respect to the vertical direction, and a horizontal engaging surface 404 opposite to the slanted surface 403.

The second engaging portion 40c is constituted as a prong, which projects from the arm 40a at a position above the first engaging portion 40b. The second engaging portion 40c has a slanted surface 405 inclined with respect to the vertical direction, and a horizontal engaging surface 406 opposite to the slanted surface 405.

As shown in FIG. 2A, the ledge 34 of the drug holder 14 can engage with the first engaging portion 40b. In an assembled state, the arm 40a can be inserted into the hole 34a in the ledge 34. When the liquid holder 18 is connected, i.e., is inserted into, the drug holder 14, the arm 40a is inserted into the hole 34a in the ledge 34. At this time, the slanted surface 403 of the first engaging portion 40b of the arm 40a presses against and then moves over and beyond the inner circumferential surface of the hole 34a. When the slanted surface 403 of the first engaging portion 40b moves over and beyond the inner circumferential surface of the hole 34a, the arm 40a snaps back under its own resilient force, thereby causing the engaging surface 404 to engage with the lower surface of the ledge 34, as shown in FIG. 2A. In this state, the liquid holder 18 and the drug holder 14 engage with each other. In the state shown in FIG. 2A, a clearance 410 is formed between the other surface 402 of the arm 40a and the inner circumferential surface of the hole 34a in the ledge 34. The engaging surface 404 of the first engaging portion 40b has a horizontal length slightly smaller than the distance provided by the clearance 410.

The arm 40a can be elastically deformed from the state shown in FIG. 2A by being pressed toward the side wall of the liquid holder 18 over the distance provided by the clearance 410. When the arm 40a is elastically deformed in this manner, the engaging surface 404 of the first engaging portion 40b is spaced from the lower surface of the ledge 34 (see FIG. 2B). The first engaging portion 40b and the ledge 34, i.e., the liquid holder 18 and the drug holder 14, do not become disengaged from each other.

As shown in FIGS. 2A and 2B, the ledge 54 of the connector 22 engages with the second engaging portion 40c. In an assembled state, the arm 40a can be inserted into the hole 54a in the ledge 54. When the liquid holder 18 is connected, i.e., is inserted into, the drug holder 14, the arm 40a is inserted into the hole 54a in the ledge 54. At this time, the slanted surface 405 of the second engaging portion 40c of the arm 40a presses against and then moves over and beyond the inner circumferential surface of the hole 54a. When the slanted surface 405 of the second engaging portion 40c moves over and beyond the inner circumferential surface of the hole 54a, the arm 40a snaps back under its own resilient force, thereby causing the engaging surface 406 to engage with the ledge 54, as shown in FIG. 2A. In this state, the liquid holder 18 and the connector 22 engage with each other.

In the state shown in FIG. 2A, a clearance 412 is formed between the other surface 402 of the arm 40a and the inner circumferential surface of the hole 54a. The engaging surface 406 of the second engaging portion 40c has a horizontal length, which is sufficiently smaller than the distance provided by the clearance 412. Therefore, even in the presence of the clearance 412, the second engaging portion 40c can engage with the ledge 54 sufficiently and reliably.

Unlike the first engaging portion 40b, the second engaging portion 40c has the engaging surface 406, which remains in engagement with the ledge 54 even when the arm 40a is elastically deformed from the state shown in FIG. 2A as a result of being pressed toward the side wall of the liquid holder 18 (regardless of whether the arm 40a is pressed or released) (see FIG. 2B).

When the first engaging portions 38b, 40b of the lock members 38, 40 engage with the ledges 32, 34, respectively, of the drug holder 14, and the second engaging portions 38c, 40c of the lock members 38, 40 engage with the ledges 52, 54, respectively, of the connector 22, the lock mechanism 37 is placed in the first state, in which the liquid holder 18 engages the connector 22 and the drug holder 14 as a whole. When the arms 38a, 40a are pressed from the first state, the first engaging portions 38b, 40b of the lock members 38, 40 disengage from the ledges 32, 34, respectively, of the drug holder 14, while the second engaging portions 38c, 40c of the lock members 38, 40 remain in engagement with the ledges 52, 54, respectively, of the connector 22. In this condition, the lock mechanism 37 is placed in the second state, in which the liquid holder 18 remains in engagement with the connector 22, but is disengaged from the drug holder 14.

According to a modification of the lock mechanism 37 shown in FIG. 1, the drug holder 14 may include lock members similar to the lock members 38, 40, and the liquid holder 18 may include ledges similar to the ledges 32, 34 for engaging with the lock members.

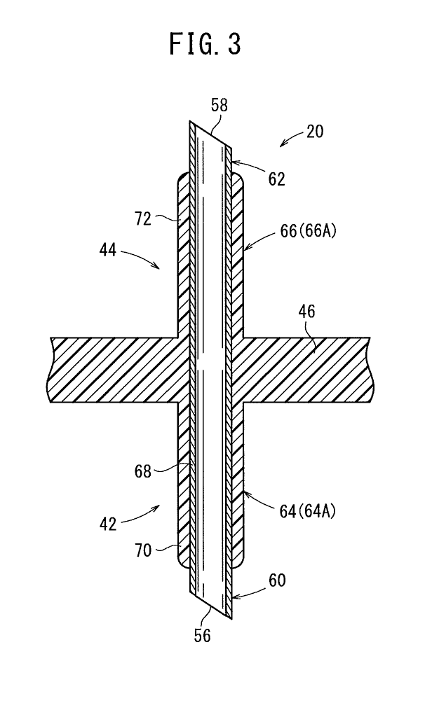

FIG. 3 is an enlarged cross-sectional view, partially omitted from illustration, showing the double-ended needle 20 integral with the connector 22 and nearby parts. As shown in FIG. 3, the first puncture needle 42 and the second puncture needle 44 include increased penetration resistance members 64, 66, respectively, disposed at positions closer to proximal end portions thereof (at the partition 46) than distal-end tubes 60, 62 including cutting faces 56, 58, and having a greater penetration resistance to the first plug 26 and the second plug 30 than the distal-end tubes 60, 62.

In the first embodiment, according to one configuration, the increased penetration resistance members 64, 66 comprise increased diameter members 64A, 66A, respectively, having an outside diameter greater than the outside diameter of the distal-end tubes 60, 62. According to another configuration (modification), the increased penetration resistance members 64, 66 may have a zigzag shape (sawtooth shape) provided by a vertical array of alternate peaks and valleys on the outer circumferential surfaces of the first puncture needle 42 and the second puncture needle 44.

According to the first embodiment, as shown in FIG. 3, the first puncture needle 42 and the second puncture needle 44 include an inner tube 68 of metal, which has a relatively small diameter (thin diameter), including the distal-end tubes 60, 62 and outer tubes 70, 72, which have a large diameter, and which surround the inner tube 68 so as to provide the increased penetration resistance members 64, 66. The distal ends of the inner tube 68, which project from the distal ends of the outer tubes 70, 72, serve as the distal-end tubes 60, 62.

The inner tube 68 may be made of stainless steel, an aluminum alloy, a copper-based alloy, or the like.

According to the first embodiment, the inner tube 68 comprises a single member shared by the first puncture needle 42 and the second puncture needle 44. However, the inner tube 68 may comprise separate members, each of which is associated respectively with the first puncture needle 42 and the second puncture needle 44.

The outer tubes 70, 72 may be made of materials, which are the same as the aforementioned materials of the drug container 12.

The outer tubes 70, 72 and the partition 46 may be formed integrally, or alternatively, may be separate members, which are secured together by adhesive bonding, welding, or the like.

According to the first embodiment, as shown in FIG. 3, the cutting face 56 of the first puncture needle 42 and the cutting face 58 of the second puncture needle 44 are inclined substantially at the same angle in one direction with respect to the axial direction (vertical direction in FIG. 3) of the double-ended needle 20. According to a modification of the first embodiment, however, the cutting face 56 of the first puncture needle 42 and the cutting face 58 of the second puncture needle 44 may be inclined in opposite directions with respect to the axial direction.

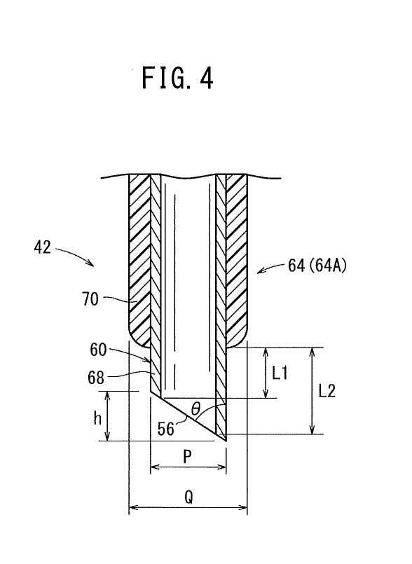

FIG. 4 is an enlarged cross-sectional view, partially omitted from illustration, illustrative of dimensions of a distal end portion of the double-ended needle 20 of the mixing instrument 10. Since the first puncture needle 42 and the second puncture needle 44 basically have the same constitution, the dimensions of the distal end portion of the first puncture needle 42 of the double-ended needle 20 will typically be described below.

As shown in FIG. 4, the outside diameter of the inner tube 68 (distal-end tube 60) is represented by P, the outside diameter of the outer tube 70 (increased diameter member 64A) is represented by Q, the distance in the axial direction from the distal end face of the outer tube 70 to the proximal end of the opening of the inner tube 68 is represented by L1, the distance in the axial direction from the distal end face of the outer tube 70 to the distal end of the opening of the inner tube 68 is represented by L2, and the angle formed between the axial direction of the inner tube 68 and the cutting face 56 is represented by θ.

P may be set to a value in a range from 1.20 mm to 1.30 mm (preferably 1.25 mm), for example. Q may be set to a value in a range from 2.25 mm to 2.35 mm (preferably 2.3 mm), for example. L1 may be set to a value in a range from 0.7 mm to 0.9 mm (preferably 0.8 mm), for example. L2 may be set to a value in a range from 1.5 mm to 1.7 mm (preferably 1.6 mm), for example. θ may be set to a value in a range from 55° to 60° (preferably 57°). The difference Q−P is preferably in a range from 0.95 to 1.15 mm.

In the illustrated mixing instrument 10, P is set to 1.25, Q is set to 2.3 mm, L1 is set to 0.8 mm, L1 is set to 1.6 mm, and θ is set to 57°. The thickness of the plug 26 is set to 3 mm.

The mixing instrument 10 according to the first embodiment is basically constituted as described above. Operations and advantages of the mixing instrument 10 will be described below.

As shown in FIG. 1, the drug container 12 is stored in the drug holder 14 and is secured to the drug holder 14 by the restraint member 36. The liquid container 16 is mounted in the liquid holder 18 and is held by the liquid holder 18.

Then, the connector 22, with the double-ended needle 20 installed therein, is inserted into the drug holder 14, such that the first puncture needle 42 is oriented toward the drug container 12. The liquid holder 18, with the liquid container 16 mounted therein, is inserted into the connector 22, such that the second plug 30 is oriented toward the second puncture needle 44.

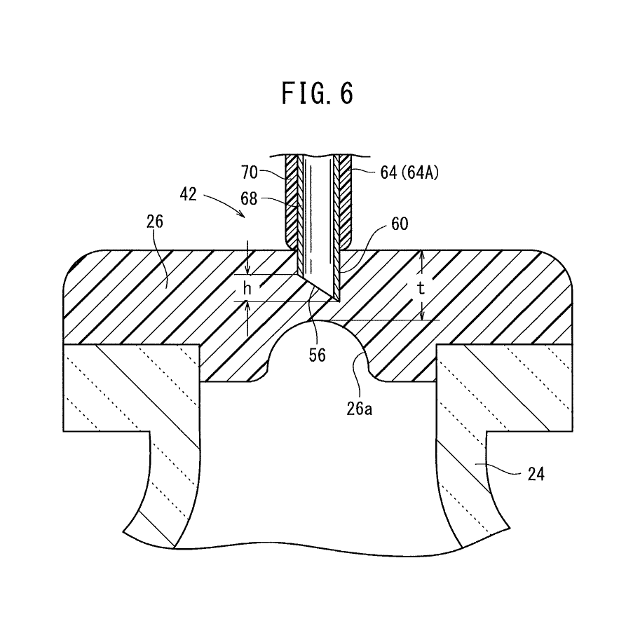

During the insertion process, as shown in FIGS. 5 and 6, the distal-end tubes 60, 62 (the portions of the inner tube 68 that project from the outer tubes 70, 72) of the first puncture needle 42 and the second puncture needle 44 pierce (are inserted into) the first plug 26 and the second plug 30. Also, distal ends of the outer tubes 70, 72, which provide the increased diameter members 64A, 66A that function as the increased penetration resistance members 64, 66, abut against the first plug 26 and the second plug 30, respectively, thereby temporarily preventing the distance that the first puncture needle 42 penetrates into the first plug 26 from increasing, and also temporarily preventing the distance that the second puncture needle 44 penetrates into the second plug 30 from increasing.

Such a state occurs because the increased diameter members 64A, 66A are larger in diameter than the distal-end tubes 60, 62, and hence the increased diameter members 64A, 66A exert an increased penetration resistance, such that the increased diameter members 64A, 66A cannot be inserted into the first plug 26 and the second plug 30 until after the distal-end tubes 60, 62 on the opposite ends have been inserted fully into the first plug 26 and the second plug 30.

As shown in FIG. 6, since the height h in the axial direction of the cutting face 56 (58) of the distal-end tube 60 (62) is smaller than the thickness t of the portion of the first plug 26 (the second plug 30), which is pierced by the first puncture needle 42 (the second puncture needle 44), when the distal end of the first puncture needle 42 is pushed into the first plug 26, the opening at the distal end of the first puncture needle 42 is closed by the first plug 26, and when the distal end of the second puncture needle 44 is pushed into the second plug 30, the opening at the distal end of the second puncture needle 44 is closed by the second plug 30. In other words, both the opening of the first puncture needle 42 and the opening of the second puncture needle 44 become closed. As shown in FIG. 6, the reverse side of the portion of the first plug 26, which is pierced by the first puncture needle 42, has a recess 26a formed therein, thereby allowing that portion of the first plug 26 to be pierced easily. The reverse side of the portion of the second plug 30, which is pierced by the second puncture needle 44, has a similar recess formed therein.

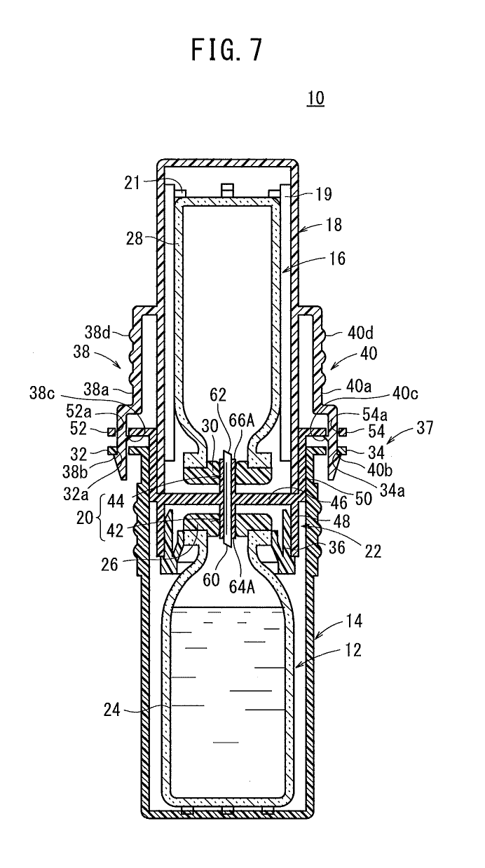

When the liquid holder 18 is pushed further toward the drug holder 14 from the state shown in FIG. 5, the mixing instrument 10 is assembled as shown in FIG. 7. The lock mechanism 37 is easily brought into the first state, as described above. More specifically, the first engaging portions 38b, 40b of the arms 38a, 40a engage with the ledges 32, 34, respectively, of the drug holder 14, whereas the second engaging portions 38c, 40c of the arms 38a, 40a engage with the ledges 52, 54, respectively, of the connector 22. In this manner, the lock mechanism 37 operates to limit the mutual positional relation between the drug container 12 and the liquid container 16, i.e., to prevent the containers 12, 16 from unduly moving, thereby reliably keeping the drug container 12 and the liquid container 16 in fluid communication with each other.

At this time, as shown in FIG. 7, the increased diameter members 64A, 66A of the first puncture needle 42 and the second puncture needle 44 pierce and penetrate the first plug 26 and the second plug 30. Therefore, the needle points (i.e., the cutting faces) of the first puncture needle 42 and the second puncture needle 44 move respectively into the drug container 12 and the liquid container 16. Thus, the drug container 12 and the liquid container 16 are brought into fluid communication with each other through the double-ended needle 20.

Inasmuch as a negative pressure is developed in the drug container 12, the liquid in the liquid container 16 is attracted to and flows into the drug container 12 through the double-ended needle 20. Thereafter, in order to mix the drug and the liquid in the drug container 12, the mixing instrument 10 is shaken several times. At this time, the drug in the drug container 12 becomes diluted and dissolved by the liquid, which has flowed into the drug container 12.

After mixing of the first component and the second component is completed, the arms 38a, 40a of the lock members 38, 40 on the liquid holder 18 are pressed inwardly toward the liquid holder 18. The first engaging portions 38b, 40b of the arms 38a, 40a disengage from the ledges 32, 34 of the drug holder 14, whereas the second engaging portions 38c, 40c of the arms 38a, 40a remain in engagement with the ledges 52, 54 of the connector 22. In other words, the lock mechanism 37 is brought into the second state.

Then, the liquid holder 18 is pulled upwardly. The liquid holder 18, in which the liquid container 16 is held, can now be released (removed) from the drug holder 14 together with the connector 22. Since the projections 38d, 40d are disposed on the outer circumferential surfaces of the arms 38a, 40a, the user finds it easy to pull the liquid holder 18, because the projections 38d, 40d function as a slip stop when the user presses the arms 38a, 40a laterally inward.

Then, the drug holder 14, from which the connector 22 has been removed, is vertically inverted. Then, the left and right side walls of the drug holder 14 are pressed inwardly to release the restraint member 36 out of engagement with the drug holder 14. The drug container 12 is released (drops) from the drug holder 14 together with the restraint member 36.

According to the first embodiment, as described above, the cutting face 56 of the first puncture needle 42 and the cutting face 58 of the second puncture needle 44 are inclined in one direction with respect to the axial direction. With this arrangement, when the first puncture needle 42 and the second puncture needle 44 pierce the first plug 26 and the second plug 30, respectively, forces acting horizontally on the first puncture needle 42 and the second puncture needle 44 cancel each other out. Therefore, the connector 22 is prevented from being pressed against the inner circumferential surface of the drug holder 14, with the result that sliding resistance between the connector 22 and the drug holder 14 is prevented from increasing when the connector 22 is inserted into the drug holder 14.

According to the first embodiment, as described above, the first puncture needle 42 and the second puncture needle 44 have respective distal-end tubes 60, 62 with openings formed in the cutting faces on the distal ends thereof. The increased penetration resistance members 64, 66 (the increased diameter members 64A, 66A) are disposed at positions closer to the proximal end portions than the distal-end tubes 60, 62, and have a greater penetration resistance to the first plug 26 and the second plug 30 than the distal-end tubes 60, 62. Therefore, when the double-ended needle 20 is connected to the drug container 12 and the liquid container 16, the distal-end tubes 60, 62, including the needle points with relatively small penetration resistance, initially are inserted into the first plug 26 and the second plug 30. Thereafter, the increased penetration resistance members 64, 66, with relatively large penetration resistance, are inserted into the first plug 26 and the second plug 30.

After the openings in the needle points of the first puncture needle 42 and the second puncture needle 44 have been closed respectively by the first plug 26 and the second plug 30, the first puncture needle 42 and the second puncture needle 44 penetrate the first plug 26 and the second plug 30, respectively. Consequently, negative pressure in the drug container 12 is maintained, and liquid is prevented from leaking out, even if the timing at which the first puncture needle 42 penetrates the first plug 26 differs from the timing at which the second puncture needle 44 penetrates the second plug 30.

More specifically, even if the first puncture needle 42 penetrates the first plug 26 before the second puncture needle 44 has penetrated the second plug 30, since the opening in the distal end of the second puncture needle 44 is closed by the second plug 30, negative pressure in the drug container 12 is maintained. Even if the second puncture needle 44 penetrates the second plug 30 before the first puncture needle 42 has penetrated the first plug 26, since the opening in the distal end of the first puncture needle 42 is closed by the first plug 26, liquid is prevented from leaking out. Accordingly, a mixing instrument 10 is provided, which can be handled easily without causing handling errors, and a piercing method is provided, which allows a double-ended needle 20 to pierce plugs simply without handling errors.

According to the first embodiment, since the increased penetration resistance members 64, 66 comprise the increased diameter members 64A, 66A, respectively, each having an outside diameter greater than the outside diameter of the distal-end tubes 60, 62, penetration resistance is increased with a simple arrangement, i.e., by a step, which is provided by the different outside diameters of the distal-end tubes 60, 62 and the increased diameter members 64A, 66A.

According to the first embodiment, since the distal-end tubes 60, 62 including the cutting edges are made of metal, the cutting edges can easily be formed as sharp edges. The cutting edges, which are formed as sharp edges, reduce the penetration resistance of the distal-end tubes 60, 62 with respect to the first plug 26 and the second plug 30, thereby reducing forces required to cause the distal-end tubes 60, 62 to pierce the first plug 26 and the second plug 30. The mixing instrument 10 can thus be handled more easily.

According to the first embodiment, when the drug holder 14, the connector 22, and the liquid holder 18 are fitted together, the components slide against each other and are guided for relative axial movement. Therefore, the first puncture needle 42 and the second puncture needle 44 can pierce the first plug 26 and the second plug 30, respectively, accurately and simply in the axial direction. Therefore, the mixing instrument 10 can be handled more easily.

According to the first embodiment, when the drug holder 14, the connector 22, and the liquid holder 18 are coupled together, the components are locked by the lock mechanism 37, so that the drug holder 14, the connector 22, and the liquid holder 18 can be handled in their entirety as an integrated mixing instrument 10. Consequently, it is easy to perform the process of shaking the mixing instrument 10 in order to accelerate mixing of the first component and the second component.

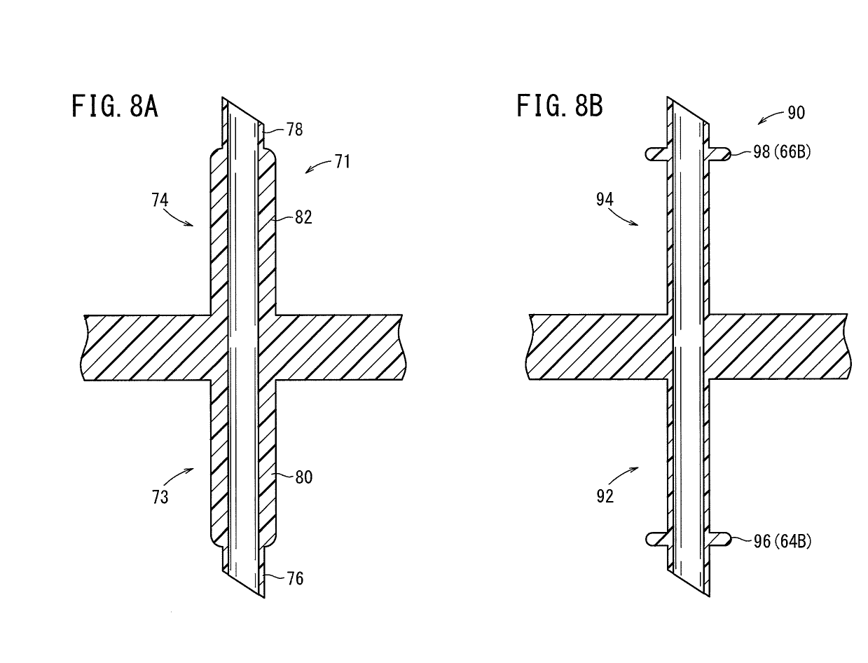

FIG. 8A is an enlarged cross-sectional view, partially omitted from illustration, showing a first modification of the double-ended needle 20, which is of the basic form according to the first embodiment of the present invention. With the basic form according to the first embodiment, the inner tube 68 provides the small-diameter distal-end tubes 60, 62, and the outer tubes 70, 72 provide the large-diameter increased diameter members 64A, 66A. According to the first modification shown in FIG. 8A, a double-ended needle 71 may comprise a first puncture needle 73 and a second puncture needle 74, including distal-end tubes 76, 78 and increased diameter members 80, 82, which are integral with each other. The first puncture needle 73 and the second puncture needle 74 may be made of materials, which are the same as the aforementioned materials of the drug holder 14.

FIG. 8B is an enlarged cross-sectional view, partially omitted from illustration, showing a second modification of the double-ended needle 20, which is of the basic form according to the first embodiment of the present invention. According to the second modification shown in FIG. 8B, a double-ended needle 90 may include increased penetration resistance members 96, 98 in the form of projections 64B, 66B, which are integral therewith, near distal end portions of a first puncture needle 92 and a second puncture needle 94, respectively. The projections 64B, 66B may be annular protrusions that extend fully around the outer circumferential surfaces of the first puncture needle 92 and the second puncture needle 94, or protrusions that extend less than fully around the outer circumferential surfaces of the first puncture needle 92 and the second puncture needle 94. The projections 64B, 66B may be a plurality of protrusions, which are spaced longitudinally (axially) along the first puncture needle 92 and the second puncture needle 94.

### Second Embodiment

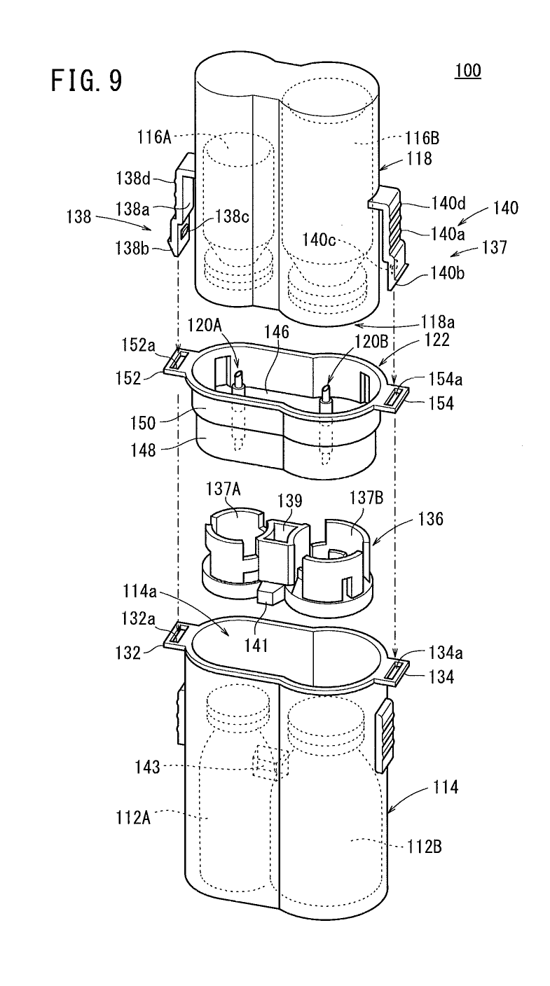

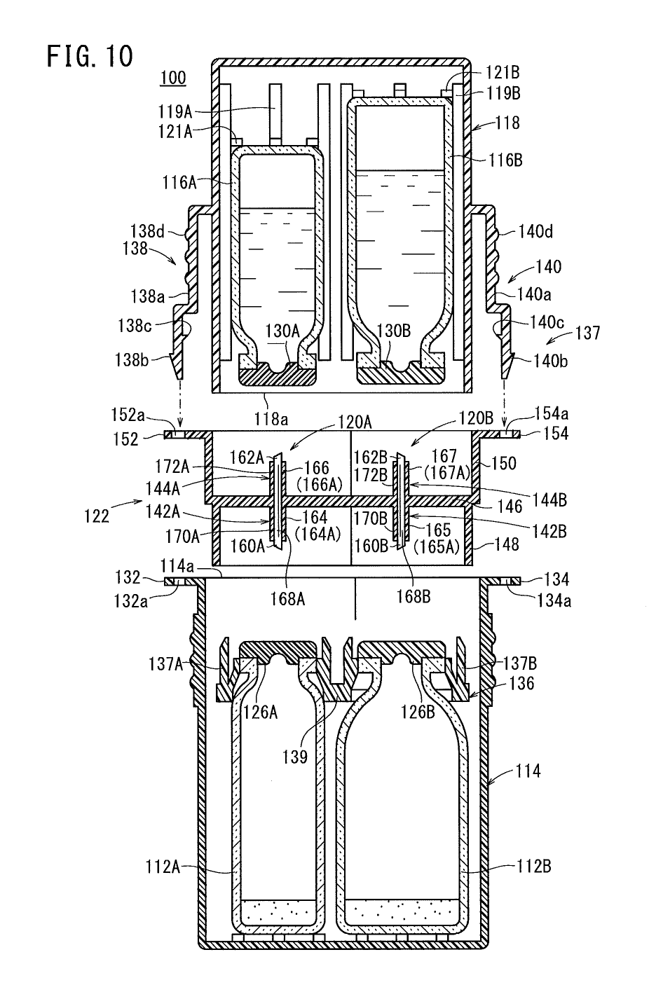

FIG. 9 is an exploded perspective view of a mixing instrument 100 according to a second embodiment of the present invention. FIG. 10 is a cross-sectional view of the mixing instrument 100 according to the second embodiment of the present invention.

As shown in FIGS. 9 and 10, the mixing instrument 10 includes two drug containers (first containers) 112A, 112B for storing a first component therein in a solid phase or a liquid phase, a drug holder (first holder) 114 in which the two drug containers 112A, 112B are mounted, two liquid containers (second containers) 116A, 116B for storing a second component in a liquid phase, a liquid holder (second holder) 118 in which two liquid containers 116A, 116B are mounted, two double-ended needles 120A, 120B, which are capable of bringing the drug containers 112A, 112B and the liquid containers 116A, 116B into fluid communication with each other, and a connector 122 to which the double-ended needles 120A, 120B are fixed. According to the first embodiment, the drug container 12, the liquid container 16, and the double-ended needle 20 each are provided as a single part. However, according to the second embodiment, such components are provided as two parts each.

The drug containers 112A, 112B are basically of the same constitution as the drug container 12. The two drug containers 112A, 112B have substantially the same constitution, except that the drug containers 112A, 112B differ in size and shape from each other. A negative pressure is developed in each of the drug containers 112A, 112B.

The liquid containers 116A, 116B are basically of the same constitution as the liquid container 16. The two liquid containers 116A, 116B are substantially of the same constitution, except that they differ in size and shape from each other.

The first component stored in the drug containers 112A, 112B may be the same drug as the first component stored in the above-described drug container 12.

The second component stored in the liquid containers 116A, 116B may be the same liquid as the second component stored in the above-described liquid container 16.

The drug holder 114 is a bottomed tubular component, which stores the two drug containers 112A, 112B therein. The drug holder 114 is made of materials, which are the same as the aforementioned materials of the drug holder 14.

The drug holder 114 has a first opening 114a formed in one end thereof. The drug containers 112A, 112B are inserted into the drug holder 114 through the first opening 114a.

The drug holder 114 also has ledges 132, 134, which project horizontally outwardly from left and right sides of the upper end thereof. The ledges 132, 134 have respective holes 132a, 134a formed vertically therethrough.

The drug holder 114 houses therein a restraint member 136 for restraining the two drug containers 112A, 112B with respect to the drug holder 114. The restraint member 136 includes a pair of tubular members 137A, 137B, which are open at upper and lower ends thereof, and a joint 139 that interconnects the tubular members 137A, 137B.

The restraint member 136 also has an engaging protrusion 141 disposed between the tubular members 137A, 137B. When the engaging protrusion 141 engages in an engaging recess 143, which is formed in an inner surface of the drug holder 114, the drug containers 112A, 112B become fixed in position with respect to the drug holder 114. Instead of the engaging recess 143, the drug holder 114 may have a hole formed in a side wall thereof, and the engaging protrusion 141 may engage in the hole.

The restraint member 136 may be made of materials, which are the same as the aforementioned materials of the drug holder 14.

The liquid holder 118 is a bottomed tubular component for storing the two liquid containers 116A, 116B. As shown in FIG. 10, the liquid holder 118 has a plurality of support guides 119A, 119B provided on the inner circumferential surface thereof for supporting the two liquid containers 116A, 116B, and a plurality of limiting projections 121A, 121B provided on the inner circumferential surface thereof for limiting the depth at which the liquid containers 116A, 116B can be inserted.

The liquid holder 118 includes a second opening 118a formed in one end thereof. The liquid containers 116A, 116B are inserted into the liquid holder 118 through the second opening 118a.

The liquid holder 118 also includes a pair of lock members 138, 140 extending downwardly from left and right sides of the outer circumferential surface thereof. The lock members 38, 40 include respective arms 138a, 140a, first engaging portions 138b, 140b, which are disposed on respective distal ends of the arms 138a, 140a, and second engaging portions 138c, 140c, which are disposed on the arms 138a, 140a more closely to the proximal ends (i.e., the upper ends thereof, as illustrated) than the first engaging portions 138b, 140b. The arms 138a, 140a have a plurality of vertically spaced projections 138d, 140d provided respectively on outer side surfaces thereof.

According to the second embodiment, the lock members 138, 140, the ledges 132, 134, and the ledges 152, 154 jointly make up a lock mechanism 137. The lock mechanism 137 serves to releasably lock the drug holder 114, the connector 122, and the liquid holder 118 inseparably when the drug holder 114, the connector 122, and the liquid holder 118 are fitted together in a relative positional relation, such that the first puncture needles 142A, 142B pierce the first plugs 126A, 126B and the second puncture needles 144A, 144B pierce the second plugs 130A, 130B.

The lock mechanism 137 can selectively be placed in a first state, in which the liquid holder 118 engages the connector 122 and the drug holder 114 as a whole, and a second state, in which the liquid holder 118 engages the connector 122 but is disengaged from the drug holder 114. The constitution and functions of the lock mechanism 137 are the same as those of the lock mechanism 37 according to the first embodiment, and such features will not be described in detail below.

According to a modification of the lock mechanism 137, lock members, which are similar to the lock members 138, 140, may be provided on the drug holder 114, and ledges, which are similar to the ledges 132, 134, may be provided on the liquid holder 118 for engaging with the lock members.

As shown in FIGS. 9 and 10, the two double-ended needles 120A, 120B have respective first puncture needles 142A, 142B that pierce the first plugs 126A, 126B, respectively, and respective second puncture needles 144A, 144B that pierce the second plugs 130A, 130B, respectively. The two double-ended needles 120A, 120B are joined to each other integrally by the connector 122.

The two first puncture needles 142A, 142B and the two second puncture needles 144A, 144B have increased penetration resistance members 164, 165, 166, 167, respectively, disposed at positions closer to proximal end portions thereof (i.e., on the partition 146) than the distal-end tubes 160A, 160B, 162A, 162B including cutting faces, and having a greater penetration resistance with respect to the first plugs 126A, 126B and the second plugs 130A, 130B than the distal-end tubes 160A, 160B, 162A, 162B.

In the second embodiment, according to one configuration, the increased penetration resistance members 164, 165, 166, 167 comprise increased diameter members 164A, 165A, 166A, 167B, respectively, having an outside diameter greater than the outside diameter of the distal-end tubes 160A, 160B, 162A, 162B. According to another configuration (modification), the increased penetration resistance members 164, 165, 166, 167 may have a zigzag shape (sawtooth shape) provided by a vertical array of alternate peaks and valleys on outer circumferential surfaces of the first puncture needles 142A, 142B and the second puncture needles 144A, 144B.

According to the second embodiment, the two first puncture needles 142A, 142B and the two second puncture needles 144A, 144B include inner tubes 168A, 168B made of metal, which are relatively small (thin) in diameter, including the distal-end tubes 160A, 160B, 162A, 162B, together with outer tubes 170A, 170B, 172A, 172B, which are relatively large in diameter, and which surround the inner tubes 168A, 168B and serve to provide the increased penetration resistance members 164, 165, 166, 167. The distal ends of the inner tubes 168A, 168B, which project from the distal ends of the outer tubes 170A, 170B, 172A, 172B, serve as the distal-end tubes 160A, 160B, 162A, 162B.

The inner tubes 168A, 168B may be made of materials, which are the same as the aforementioned materials of the inner tube 68 according to the first embodiment. The outer tubes 170A, 170B, 172A, 172B may be made of materials, which are the same as the aforementioned materials of the outer tubes 70, 72 according to the first embodiment.

According to the second embodiment, one of the inner tubes 168A comprises a single member, which is shared by the first puncture needle 142A and the second puncture needle 144A. However, the inner tube 168A may comprise separate members associated respectively with the first puncture needle 142A and the second puncture needle 144A. The same holds true for the other inner tube 168B.

The outer tubes 170A, 170B, 172A, 172B may be made of materials, which are the same as the aforementioned materials of the drug containers 112A, 112B.

The outer tubes 170A, 170B, 172A, 172B and the partition 146 may be formed integrally with each other, or alternatively, the outer tubes 170A, 170B, 172A, 172B may be separate members secured together by adhesive bonding, welding, or the like.

According to the second embodiment, the cutting faces of the first puncture needles 142A, 142B and the cutting faces of the second puncture needles 144A, 144B are inclined in opposite directions with respect to the axial direction of the double-ended needles 120A, 120B, at substantially the same absolute angle. The angle is set such that the gradients of one of the first puncture needles 142A and the other first puncture needle 142B are mirror images of each other (in point symmetry) with respect to a vertical line that extends between the double-ended needles 120A, 120B. Similarly, the angle is set such that the gradients of one of the second puncture needles 144A and the other second puncture needle 144B are mirror images of each other (in point symmetry) with respect to a vertical line that extends between the double-ended needles 120A, 120B.

According to a modification of the second embodiment, however, the cutting faces of the first puncture needles 142A, 142B and the cutting faces of the second puncture needles 144A, 144B may be inclined in one direction with respect to the axial direction, as is the case with the double-ended needle 20 according to the first embodiment shown in FIG. 2.

The connector 122 has a partition 146 extending horizontally, a lower side wall 148 extending downwardly from the partition 146, and an upper side wall 150 extending upwardly from the partition 146. The two first puncture needles 142A, 142B are mounted on the lower surface of the partition 146, whereas the two second puncture needles 144A, 144B are mounted on the upper surface of the partition 146. The connector 122 may be made of materials, which are the same as the aforementioned materials of the drug holder 14.

The lower side wall 148 surrounds the two first puncture needles 142A, 142B as a whole. The lower side wall 148 has a height (vertical dimension), which is greater than the height of the two first puncture needles 142A, 142B, so that the distal ends (cutting faces) of the two first puncture needles 142A, 142B do not project downwardly from the lower end of the lower side wall 148.

The upper side wall 150 surrounds the two second puncture needles 144A, 144B in their entirety. The upper side wall 150 has a height greater than the height of the two second puncture needles 144A, 144B, so that the distal ends (cutting faces) of the two second puncture needles 144A, 144B do not project upwardly from the upper side wall 150. The upper side wall 150 has ledges 152, 154 projecting horizontally outwardly from the left and right sides of the upper end thereof. The ledges 152, 154 have respective holes 152a, 154a formed vertically therethrough.

The connector 122 can be inserted into the drug holder 114, with the outer circumferential surface of the upper side wall 150 thereof serving as a sliding surface. More specifically, the connector 122 can move longitudinally (vertically) along the double-ended needles 120A, 120B with respect to the drug holder 114.

The liquid holder 118 can be inserted into the connector 122 with the outer circumferential surface of the lower end portion thereof serving as a sliding surface. More specifically, the liquid holder 118 is capable of moving longitudinally along the double-ended needles 120A, 120B with respect to the connector 122.

The dimensions and angles of the distal end portions of the two double-ended needles 120A, 120B may be set in the same manner as the dimensions P, Q, L1, L2 and the angle θ (see FIG. 4) of the aforementioned corresponding portions according to the first embodiment.

The mixing instrument 100 according to the second embodiment is basically constituted as described above. Operations and advantages of the mixing instrument 100 will be described below.

As shown in FIG. 10, the drug containers 112A, 112B are stored in the drug holder 114, and are secured to the drug holder 114 by the restraint member 136. The liquid containers 116A, 116B are mounted in the liquid holder 118 and are held by the liquid holder 118.

Then, the connector 122, with the two double-ended needles 120A, 120B installed therein, is inserted into the drug holder 114 such that the two first puncture needles 142A, 142B are oriented toward the drug containers 112A, 112B. Further, the liquid holder 118, with the two liquid containers 116A, 116B mounted therein, is inserted into the connector 122 such that the second plugs 130A, 130B are oriented toward the second puncture needles 144A, 144B.

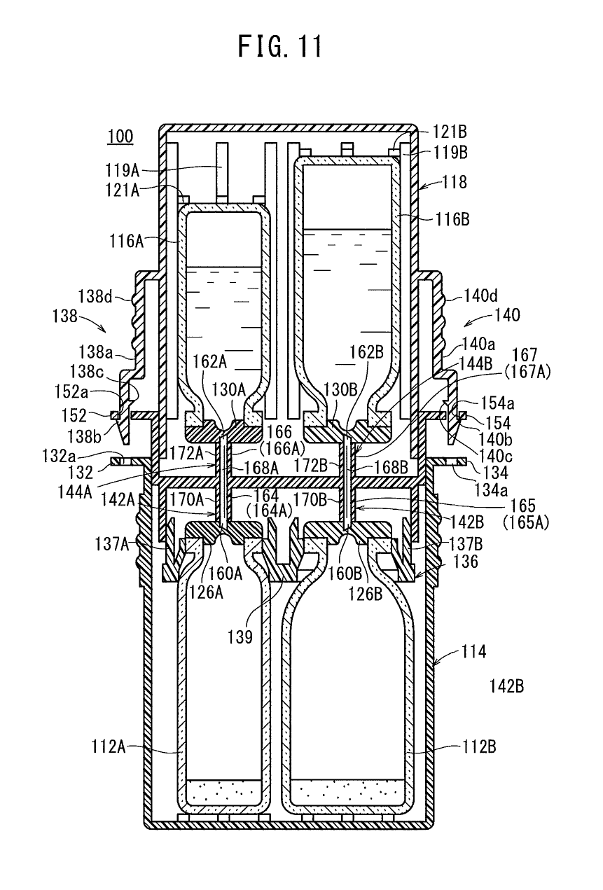

During the insertion process, as shown in FIG. 11, the distal-end tubes 160A, 160B, 162A, 162B (i.e., the portions of the inner tubes 168A, 168B that project from the outer tubes 170A, 170B, 172A, 172B) of the first puncture needles 142A, 142B and the second puncture needles 144A, 144B pierce (are inserted into) the first plugs 126A, 126B and the second plugs 130A, 130B, and the distal ends of the outer tubes 170A, 170B, 172A, 172B, which provide the increased diameter members 164A, 165A, 166A, 167A that function as the increased penetration resistance members 164, 165, 166, 167, abut against the first plugs 126A, 126B and the second plugs 130A, 130B, respectively, thereby temporarily preventing the distance by which the first puncture needles 142A, 142B are inserted into the first plugs 126A, 126B from increasing, as well as temporarily preventing the distance by which the second puncture needles 144A, 144B are inserted into the second plugs 130A, 130B from increasing.

Such a condition occurs because the increased diameter members 164A, 165A, 166A, 167A are larger in diameter than the distal-end tubes 160A, 160B, 162A, 162B, and hence the increased diameter members 164A, 165A, 166A, 167A exert an increased penetration resistance, such that the increased diameter members 164A, 165A, 166A, 167A cannot be inserted into the first plugs 126A, 126B and the second plugs 130A, 130B until after the distal-end tubes 160A, 160B, 162A, 162B on the opposite ends thereof have been inserted fully into the first plugs 126A, 126B and the second plugs 130A, 130B.

Since the height in the axial direction of the cutting faces of the distal-end tubes 160A, 160B, 162A, 162B is smaller than the thickness of the portions of the first plugs 126A, 126B and the second plugs 130A, 130B, which are pierced by the first puncture needles 142A, 142B and the second puncture needles 144A, 144B, the openings at the distal ends of the first puncture needles 142A, 142B are closed by the first plugs 126A, 126B, and the openings at the distal ends of the second puncture needles 144A, 144B are closed by the second plugs 130A, 130B. In other words, both openings of the first puncture needles 142A, 142B and both openings of the second puncture needles 144A, 144B are closed.

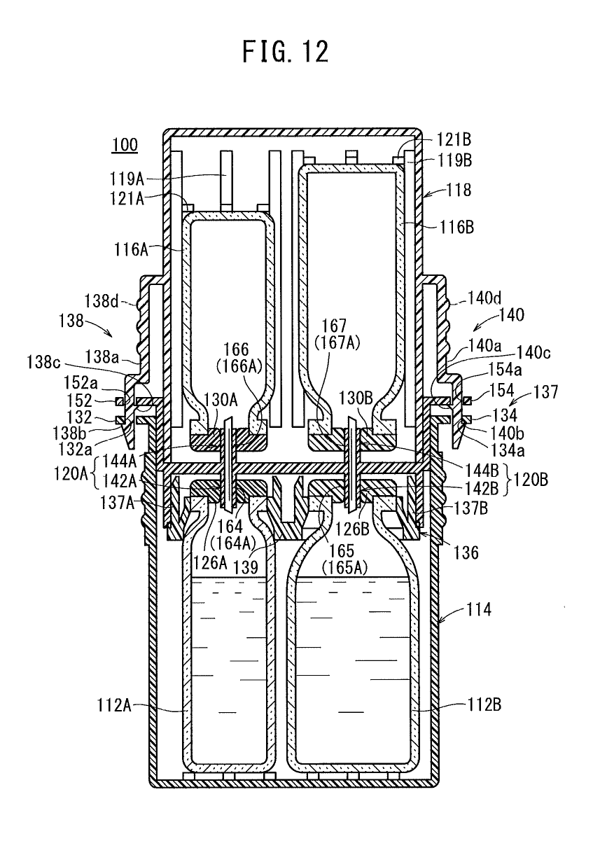

When the liquid holder 118 is further pushed toward the drug holders 114 from the state shown in FIG. 11, the mixing instrument 100 is assembled together, as shown in FIG. 12. The lock mechanism 137 is easily brought into the first state, as described above. More specifically, the first engaging portions 138b, 140b of the arms 138a, 140a engage with the respective ledges 132, 134 of the drug holder 114, and the second engaging portions 138c, 140c of the arms 138a, 140a engage the respective ledges 152, 154 of the connector 122. The lock mechanism 137 thus operates to limit the mutual positional relation between the drug containers 112A, 112B and the liquid containers 116A, 116B, i.e., to prevent the containers 112A, 112B, 116A, 116B from unduly moving, thereby reliably maintaining the drug containers 112A, 112B and the liquid containers 116A, 116B in fluid communication with each other.

At this time, as shown in FIG. 12, the increased diameter members 164A, 165A, 166A, 167A of the first puncture needles 142A, 142B and the second puncture needles 144A, 144B pierce the first plugs 126A, 126B and the second plugs 130A, 130B, respectively, and the needle points (the cutting faces) of the first puncture needles 142A, 142B and the second puncture needles 144A, 144B move respectively into the drug containers 112A, 112B and the liquid containers 116A, 116B. At this time, the two drug containers 112A, 112B and the two liquid containers 116A, 116B are brought into fluid communication with each other by the corresponding double-ended needles 120A, 120B.

Inasmuch as a negative pressure is developed in the two drug containers 112A, 112B, liquid in the liquid containers 116A, 116B is attracted to and flows into the drug containers 112A, 112B through the two double-ended needles 120A, 120B. Thereafter, the mixing instrument 100 is shaken several times. At this time, the drugs in the drug containers 112A, 112B become diluted and are dissolved by the liquids that flow into the drug containers 112A, 112B.

After mixing of the drug and the liquid is completed, the arms 138a, 140a of the lock members 138, 140 on the liquid holder 118 are pressed inwardly toward the liquid holder 118. The first engaging portions 138b, 140b of the arms 138a, 140a disengage from the ledges 132, 134 of the drug holder 114, whereas the second engaging portions 138e, 140e of the arms 138a, 140a remain in engagement with the ledges 152, 154 of the connector 122. In other words, the lock mechanism 137 is brought into the second state.

Then, the liquid holder 118 is pulled upwardly. The liquid holder 118, which holds the liquid containers 116A, 116B therein, can now be released (removed) from the drug holder 114 together with the connector 122. Since the projections 138d, 140d are disposed on the arms 138a, 140a, the user finds it easy to pull the liquid holder 118, because the projections 138d, 140d function as a slip stop.

Then, the drug holder 114, from which the connector 122 has been removed, is vertically inverted. Then, the left and right side walls of the drug holder 114 are pressed inwardly to cause the engaging protrusion 141 of the restraint member 136 to disengage from the engaging recess 143 of the drug holder 114. The drug containers 112A, 112B are released (drop) from the drug holder 114 together with the restraint member 136.

According to the second embodiment, as described above, the cutting faces of the first puncture needles 142A, 142B and the cutting faces of the second puncture needles 144A, 144B are inclined in opposite directions with respect to the axial direction, and one of the double-ended needles 120A and the other double-ended needle 120B are mirror images of each other. With this arrangement, when the two double-ended needles 120A, 120B pierce into the first plugs 126A, 126B and the second plugs 130A, 130B, respectively, forces acting horizontally on the two double-ended needles 120A, 120B cancel each other out. Therefore, sliding resistance between the connector 122 and the drug holder 114 is prevented from increasing when the connector 122 is inserted into the drug holder 114.

According to the second embodiment, as described above, the first puncture needles 142A, 142B and the second puncture needles 144A, 144B have respective distal-end tubes 160A, 160B, 162A, 162B with openings formed in the cutting faces on distal ends thereof, and the increased penetration resistance members 164, 165, 166, 167 (increased diameter members 164A, 165A, 166A, 167A), which are disposed at positions closer to proximal end portions thereof than the distal-end tubes 160A, 160B, 162A, 162B, and having a greater penetration resistance to the first plugs 126A, 126B and the second plugs 130A, 130B than the distal-end tubes 160A, 160B, 162A, 162B. Therefore, when the double-ended needles 120A, 120B are connected to the drug containers 112A, 112B and the liquid containers 116A, 116B, the distal-end tubes 160A, 160B, 162A, 162B, which include the needle points with a relatively small penetration resistance, are inserted initially into the first plugs 126A, 126B and the second plugs 130A, 130B, and then the increased penetration resistance members 164, 165, 166, 167, which have a relatively large penetration resistance, are inserted into the first plugs 126A, 126B and the second plugs 130A, 130B.

After the openings in the needle points of the first puncture needles 142A, 142B and the second puncture needles 144A, 144B have been closed respectively by the first plugs 126A, 126B and the second plugs 130A, 130B, the first puncture needles 142A, 142B and the second puncture needles 144A, 144B penetrate the first plugs 126A, 126B and the second plugs 130A, 130B, respectively. Consequently, negative pressure in the drug containers 112A, 112B is maintained and liquids are prevented from leaking out, even if the timing at which the first puncture needles 142A, 142B penetrate the first plugs 126A, 126B differs from the timing at which the second puncture needles 144A, 144B penetrate the second plugs 130A, 130B.

More specifically, even if the first puncture needles 142A, 142B penetrate the first plugs 126A, 126B before the second puncture needles 144A, 144B penetrate the second plugs 130A, 130B, since the openings in the distal ends of the second puncture needles 144A, 144B are closed by the second plugs 130A, 130B, negative pressure in the drug containers 112A, 112B is maintained. Further, even if the second puncture needles 144A, 144B penetrate the second plugs 130A, 130B before the first puncture needles 142A, 142B penetrate the first plugs 126A, 126B, since the openings in the distal ends of the first puncture needles 142A, 142B are closed by the first plugs 126A, 126B, liquids are prevented from leaking out. Accordingly, a mixing instrument 100 is provided, which can be handled easily without causing handling errors, while in addition, a piercing method is provided for allowing double-ended needles 120A, 120B to pierce plugs simply without handling errors, by maintaining negative pressure in the drug containers 112A, 112B and preventing liquids from leaking out, even if the timing at which the first puncture needles 142A, 142B penetrate the first plugs 126A, 126B differs from the timing at which the second puncture needles 144A, 144B penetrate the second plugs 130A, 130B.

According to the second embodiment, since the increased penetration resistance members 164, 165, 166, 167 comprise the increased diameter members 164A, 165A, 166A, 167A, respectively, which have an outside diameter greater than the outside diameter of the distal-end tubes 160A, 160B, 162A, 162B, penetration resistance is increased with a simple arrangement, due to the step, which is formed by the different outside diameters of the distal-end tubes 160A, 160B, 162A, 162B and the increased diameter members 164A, 165A, 166A, 167A.

According to the second embodiment, since the distal-end tubes 160A, 160B, 162A, 162B including the cutting edges are made of metal, the cutting edges can easily be formed as sharp edges. The cutting edges, which are formed as sharp edges, reduce the penetration resistance of the distal-end tubes 160A, 160B, 162A, 162B with respect to the first plugs 126A, 126B and the second plugs 130A, 130B, thereby reducing the forces required to cause the distal-end tubes 160A, 160B, 162A, 162B to pierce the first plugs 126A, 126B and the second plugs 130A, 130B. Thus, the mixing instrument 100 can be handled more easily.

According to the second embodiment, when the drug holder 114, the connector 122, and the liquid holder 118 are fitted together, the drug holder 114, the connector 122, and the liquid holder 118 slide against each other and are guided for relative axial movement. Therefore, the first puncture needles 142A, 142B and the second puncture needles 144A, 144B are capable of piercing the first plugs 126A, 126B and the second plugs 130A, 130B, respectively, accurately and simply in the axial direction. Therefore, the mixing instrument 100 can be handled more easily.

According to the second embodiment, when the drug holder 114, the connector 122, and the liquid holder 118 are coupled together, the drug holder 114, the connector 122, and the liquid holder 118 are locked by the lock mechanism 137, so that the drug holder 114, the connector 122, and the liquid holder 118 can be handled in their entirety as an integrated mixing instrument 100. Consequently, it is easy to perform the process of shaking the mixing instrument 100 in order to accelerate mixing of the first component and the second component.

One or both of the two double-ended needles 120A, 120B may be constituted in the same manner as the double-ended needle 71 shown in FIG. 8A, or may be constituted in the same manner as the double-ended needle 90 shown in FIG. 8B.

### Third Embodiment

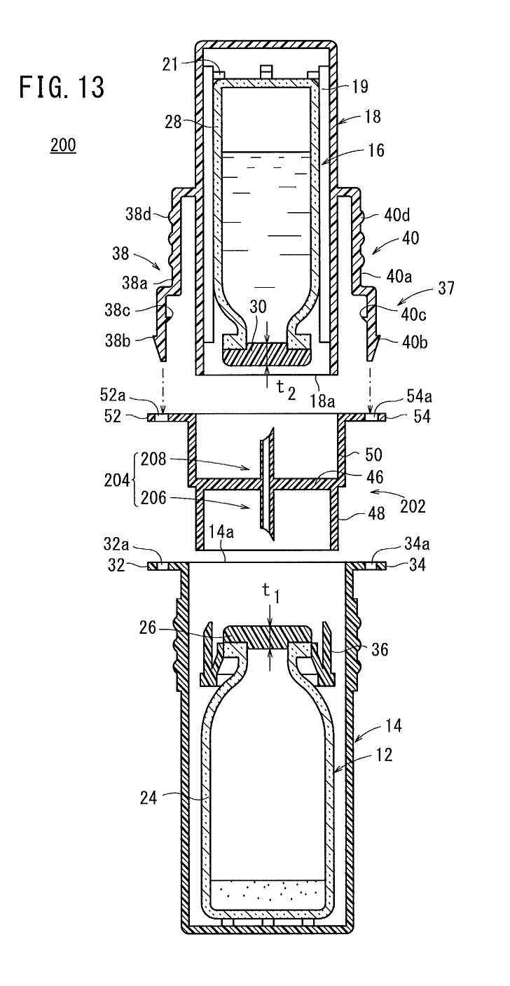

FIG. 13 is a cross-sectional view of a mixing instrument 200 according to a third embodiment of the present invention. Components of the mixing instrument 200 according to the third embodiment, which have identical or similar functions and advantages to those of the mixing instrument 10 according to the first embodiment, are denoted by identical reference characters, and such features will not be described in detail below.

The mixing instrument 200 includes a connector 202 that is used in place of, and differs in constitution from the connector 22 of the mixing instrument according to the first embodiment. The connector 202 has a double-ended needle 204 that brings the drug container 12 and the liquid container 16 into fluid communication with each other. The double-ended needle 204 includes a first puncture needle 206 for piercing the first plug 26 and a second puncture needle 208 for piercing the second plug 30. The double-ended needle 204 is formed integrally with the connector 202.

Other constitutive details of the connector 202 are the same as those of the connector 22 of the mixing instrument according to the first embodiment. More specifically, the connector 202 has a partition 46 extending horizontally, a lower side wall 48 extending downwardly from the partition 46, and an upper side wall 50 extending upwardly from the partition 46. The first puncture needle 206 is mounted on the lower surface of the partition 46, whereas the second puncture needle 208 is mounted on the upper surface of the partition 46.

The lower side wall 48 surrounds the first puncture needle 206. The lower side wall 48 has a height (vertical dimension), which is greater than the height of the first puncture needle 206, so that the distal end (cutting face) of the first puncture needle 206 does not project downwardly from the lower end of the lower side wall 48.

The upper side wall 50 surrounds the second puncture needle 208. The upper side wall 50 has a height, which is greater than the height of the second puncture needle 208, so that the distal end (cutting face) of the second puncture needle 208 does not project upwardly from the upper side wall 50.

The connector 202 can be inserted into the drug holder 14 such that the outer circumferential surface of the upper side wall 50 serves as a sliding surface. More specifically, the connector 202 can slide longitudinally (vertically) along the double-ended needle 204 into fitting engagement with the drug holder 14.

The mixing instrument 200 includes a lock mechanism 37, which is identical in constitution to the lock mechanism 37 of the mixing instrument 10. The lock mechanism 37 serves to releasably lock the drug holder 14, the connector 202, and the liquid holder 18 inseparably together, when the drug holder 14, the connector 202, and the liquid holder 18 are fitted together in a relative positional relation, such that the first puncture needle 206 pierces the first plug 26 and the second puncture needle 208 pierces the second plug 30.

According to a modification of the lock mechanism 37 shown in FIG. 13, the drug holder 14 may have lock members similar to the lock members 38, 40, and the liquid holder 18 may have ledges similar to the ledges 32, 34 for engaging with the lock members.

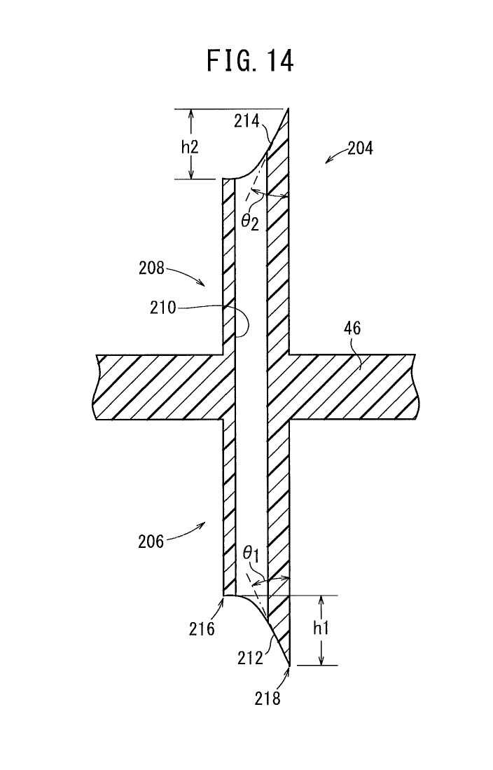

FIG. 14 is an enlarged cross-sectional view, partially omitted from illustration, showing the double-ended needle 204, which is formed integrally with the connector 202, and nearby parts. As shown in FIG. 14, the double-ended needle 204 has a lumen 210 (bore) extending longitudinally (axially), and which is open at opposite ends thereof. One of the openings of the lumen 210 opens at a cutting face 212 of the first puncture needle 206, and the other opening of the lumen 210 opens at a cutting face 214 of the second puncture needle 208.

Respective needle point angles θ1, θ2 of the first puncture needle 206 and the second puncture needle 208, and respective elastic characteristics of the first plug 26 and the second plug 30 are established, such that when the first plug 26 is pressed by the first puncture needle 206 and the second plug 30 is pressed by the second puncture needle 208, the openings at the opposite ends of the lumen 210 of the double-ended needle 204 are sealed by the first plug 26 and the second plug 30, respectively.

The first puncture needle 206 and the second puncture needle 208 may be made of materials, which are the same as the aforementioned materials of the drug holder 14.

The first puncture needle 206 and the partition 46 may be formed integrally with each other, or alternatively, may be formed as separate members, which are secured together by adhesive bonding, welding, or the like. Likewise, the second puncture needle 208 and the partition 46 may be formed integrally with each other, or alternatively, may be formed as separate members, which are secured together by adhesive bonding, welding, or the like. For example, the first puncture needle 206 and the second puncture needle 208 may be made of metal, preferably SUS, whereas the connector 202 itself may be integrally molded from a resin material.

According to the third embodiment, as shown in FIG. 14, the first puncture needle 206 and the second puncture needle 208 have respective cutting faces 212, 214, which are shaped as concave surfaces and are curved as viewed in vertical cross section. Typically, with respect to the first puncture needle 206, the gradient of the cutting face 212 with respect to the axial direction increases progressively from a proximal end portion 216 toward a distal end portion 218 thereof.

The cutting face 212 of the first puncture needle 206 and the cutting face 214 of the second puncture needle 208 are oriented in one direction with respect to directions (horizontal directions in FIG. 14) perpendicular to the axial direction.

As shown in FIG. 14, the height h1 in the axial direction of the cutting face 212 of the first puncture needle 206 is smaller than the thickness t1 (see FIG. 13) of the portion of the first plug 26 that is pierced by the first puncture needle 206. Similarly, the height h2 in the axial direction of the cutting face 214 of the second puncture needle 208 is smaller than the thickness t2 (see FIG. 13) of the portion of the second plug 30 that is pierced by the second puncture needle 208. The thicknesses t1, t2 of such portions of the first plug 26 and the second plug 30 are preferably in the range from 1 to 4 mm, and more preferably, in the range from 2.0 to 2.5 mm.

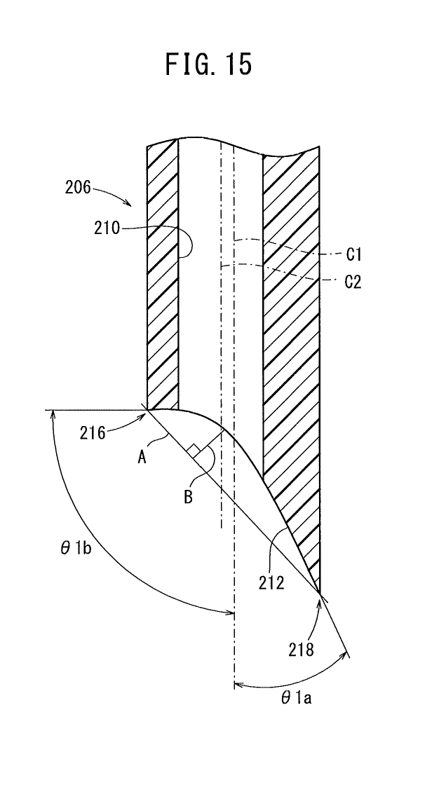

FIG. 15 is an enlarged cross-sectional view, partially omitted from illustration, showing the first puncture needle 206 and nearby parts of the double-ended needle 204 of the mixing instrument 200. Since the constitution of the first puncture needle 206 and the second puncture needle 208 are basically the same, the shape of the first puncture needle 206 of the double-ended needle 204 will typically be described below.

According to the third embodiment, as shown in FIG. 15, a line segment A extends between the distal end portion 218 and the proximal end portion 216 of the cutting face 212, and a line B normal to the line segment A extends from a deepest point on the concave surface (the cutting face 212). The point of intersection between the line segment A and the line B is positioned closer to the proximal end portion 216 of the cutting face 212 than the midpoint of the line segment A. The distance between the point of intersection and the distal end portion 218 of the cutting face 212 is set to a value, which is in the range of ⅗ to ⅘ the length of the line segment A. In other words, the cutting face (the concave surface) 212 has a curved shape, the concavity of which is formed more deeply near the proximal end portion 216 than near the distal end portion 218. The center C2 of the lumen 210 is closer to the proximal end portion 216 of the cutting face 212 than the central line C1 of the first puncture needle 206.

The angle θ1a formed between a line tangential to the distal end portion 218 of the cutting face 212 and the central line C1 is preferably of a value in the range from 5° to 40°, and more preferably, in the range from 10° to 30°. If the angle θ1a is smaller than 5°, then the mechanical strength of the cutting edge is reduced to such an extent that when the cutting edge attempts to pierce the first plug 26, the distal end tends to become bent, and it is difficult to pierce the first plug 26. If the angle θ1a is in excess of 40°, then the cutting edge has an obtuse angle, thus presenting a large penetration resistance when the cutting edge attempts to pierce the first plug 26, and making the first puncture needle 206 poor in operability.

The angle θ1b formed between a line tangential to the proximal end portion 216 of the cutting face 212 and the central line C1 is preferably of a value in the range from 90° to 150°, and more preferably, in the range from 100° to 130°. If the angle θ1b is smaller than 90°, then the lumen 210 extends to the proximal end of the first puncture needle 206, and the sealing capability at the time that the first puncture needle 206 contacts the first plug 26 is lost. Further, the extending portion of the lumen 210 tends to hollow out the first plug 26, resulting in coring. If the angle θ1b is in excess of 150°, then when the first puncture needle 206 pierces the first plug 26, the cutting face 212 does not come into full contact with the first plug 26, resulting in poor sealing capability.

In the illustrated mixing instrument 200, θ1a is set to 30° and θ1b is set to 110°.

The mixing instrument 200 according to the third embodiment is basically constituted as described above. Operations and advantages of the mixing instrument 200 will be described below.

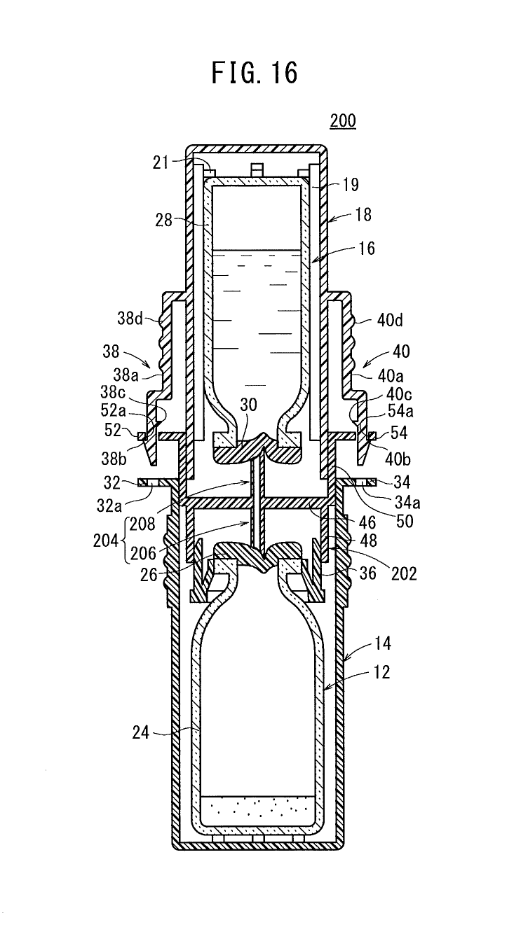

As shown in FIG. 16, the drug container 12 is held by the drug holder 14, and is secured in the drug holder 14 by the restraint member 36. The liquid container 16 also is mounted in the liquid holder 18 and is held by the liquid holder 18.

Then, the connector 202, with the double-ended needle 204 installed therein, is inserted into the drug holder 14 with the first puncture needle 206 being oriented toward the drug container 12. The liquid holder 18, with the liquid container 16 mounted therein, is inserted into the connector 202 with the second plug 30 being oriented toward the second puncture needle 208.

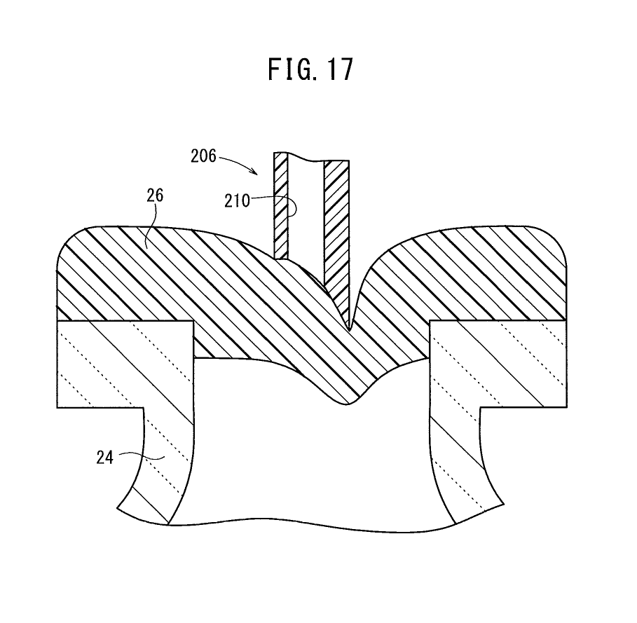

During the insertion process, as shown in FIG. 16, the first puncture needle 206 is pressed against the first plug 26, and the second puncture needle 208 is pressed against the second plug 30, whereby the first plug 26 and the second plug 30 are elastically deformed. FIG. 17 is an enlarged cross-sectional view, partially omitted from illustration, showing the first puncture needle 206, the first plug 26, and nearby parts at this time.

As described above, the respective needle point angles θ1, θ2 of the first puncture needle 206 and the second puncture needle 208, and the elastic characteristics of the first plug 26 and the second plug 30 are established, such that when the first puncture needle 206 is pressed by the first plug 26 and the second puncture needle 208 is pressed by the second plug 30, openings in opposite ends of the lumen 210 of the double-ended needle 204 are sealed by the first plug 26 and the second plug 30, respectively. When the double-ended needle 204 pierces the first plug 26 and the second plug 30, the first plug 26, which is pressed by the first puncture needle 206, and the second plug 30, which is pressed by the second puncture needle 208, are elastically deformed, so that the first plug 26 is held in close contact with the cutting face 212 of the first puncture needle 206 and the second plug 30 is held in close contact with the cutting face 214 of the second puncture needle 208. As a result, openings in opposite ends of the lumen 210 are sealed respectively by the first plug 26 and the second plug 30.

According to the double-ended needles of the background art, the needle point angles are relatively small, so as to reduce the resistance that the double-ended needles undergo when the double-ended needles penetrate the plugs. Therefore, the double-ended needles penetrate the plugs easily. According to the double-ended needles of the background art, consequently, the openings in the opposite ends of the lumen cannot be sealed simultaneously by the plugs.

According to the third embodiment of the present invention, the needle point angles of the first puncture needle 206 and the second puncture needle 208 are greater than in the double-ended needles of the background art, thereby intentionally lowering the forces with which the first puncture needle 206 and the second puncture needle 208 penetrate (pierce) the first plug 26 and the second plug 30. Therefore, the first plug 26 and the second plug 30 are elastically deformed significantly, so as to seal the openings in the opposite ends of the lumen 210.

Whether or not the openings in the opposite ends of the lumen 210 can be sealed by the first plug 26 and the second plug 30 is determined by the forces applied by the first puncture needle 206 and the second puncture needle 208 to penetrate the first plug 26 and the second plug 30 (i.e., the sharpness of the needle points), together with the elastic characteristics, such as hardness and elongation characteristics, of the first plug 26 and the second plug 30. Therefore, the needle point angles θ1, θ2 of the first puncture needle 206 and the second puncture needle 208 are established in view of the elastic characteristics of the first plug 26 and the second plug 30.

According to the third embodiment, the proximal end areas of the cutting faces 212, 214, which are formed as concave surfaces of the first puncture needle 206 and the second puncture needle 208, function as chins. Since such chins increase the penetration resistance with which the first plug 26 and the second plug 30 are penetrated, when the distal ends of the first puncture needle 206 and the second puncture needle 208 bite into the first plug 26 and the second plug 30, the chins temporarily bear the first plug 26 and the second plug 30. Since the openings of the lumen 210 are positioned closer to the proximal end portions (the chins) of the cutting faces 212, 214 than the needle central line C1, while the chins bear the first plug 26 and the second plug 30, the openings in the opposite ends of the lumen 210 are sealed simultaneously by the first plug 26 and the second plug 30.

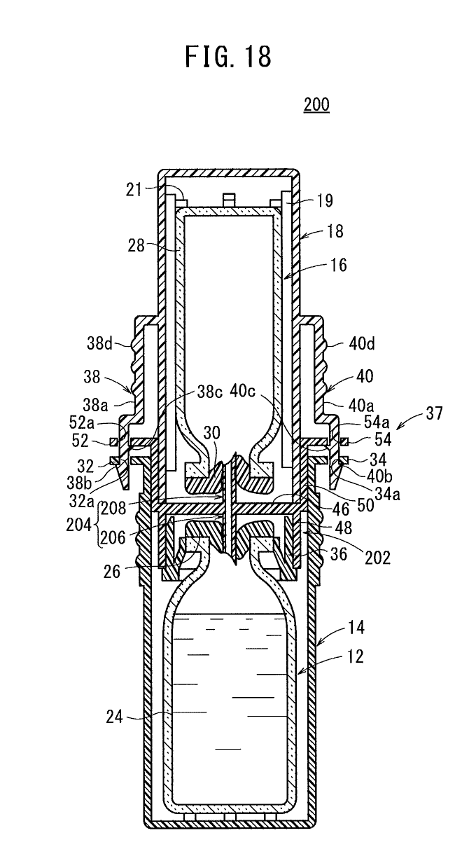

When the liquid holder 18 is further pushed toward the drug holder 14 from the state shown in FIG. 16, the mixing instrument 200 becomes assembled, as shown in FIG. 18. The lock mechanism 37 is easily brought into the aforementioned first state. More specifically, the first engaging portions 38b, 40b of the arms 38a, 40a engage with the ledges 32, 34, respectively, of the drug holder 14, and the second engaging portions 38c, 40c of the arms 38a, 40a engage with the ledges 52, 54, respectively, of the connector 22. In this manner, the lock mechanism 37 operates to limit the mutual positional relation between the drug container 12 and the liquid container 16, i.e., to prevent the containers 12, 16 from unduly moving, thereby reliably maintaining the drug container 12 and the liquid container 16 in fluid communication with each other.

When the liquid holder 18 is further pushed toward the drug holder 14 from the state shown in FIG. 18, and the distance that the first puncture needle 206 bites into the first plug 26 increases to a certain extent, the first plug 26 is no longer capable of withstanding the pressure from the first puncture needle 206, and the first puncture needle 206 then pierces the first plug 26. Similarly, when the distance that the second puncture needle 208 bites into the second plug 30 increases to a certain extent, the second plug 30 is no longer capable of withstanding the pressure from the second puncture needle 208, and the second puncture needle 208 then pierces the second plug 30. The cutting faces 212, 58 of the first puncture needle 206 and the second puncture needle 208 move into the drug container 12 and the liquid container 16, respectively, whereby the drug container 12 and the liquid container 16 are brought into fluid communication with each other by the double-ended needle 204.

Inasmuch as a negative pressure is developed in the drug container 12, the liquid in the liquid container 16 is attracted to and flows into the drug container 12 through the double-ended needle 204. Thereafter, in order to mix the drug and the liquid in the drug container 12, the mixing instrument 200 is shaken several times. The drug in the drug container 12 becomes diluted and dissolved by the liquid that has flowed into the drug container 12.

After mixing of the first component and the second component is completed, the arms 38a, 40a of the lock members 38, 40 on the liquid holder 18 are pressed inwardly toward the liquid holder 18. The first engaging portions 38b, 40b of the arms 38a, 40a disengage from the ledges 32, 34 of the drug holder 14, whereas the second engaging portions 38c, 40c of the arms 38a, 40a remain in engagement with the ledges 52, 54 of the connector 202. In other words, the lock mechanism 37 is brought into the second state.

Then, the liquid holder 18 is pulled upwardly. The liquid holder 18, which holds the liquid container 16 therein, can now be released (removed) from the drug holder 14 together with the connector 22. Since the projections 38d, 40d are disposed on outer circumferential surfaces of the arms 38a, 40a, the user finds it easy to pull the liquid holder 18, because the projections 38d, 40d function as a slip stop when the arms 38a, 40a are pressed laterally inward.

Then, the drug holder 14, from which the connector 202 has been removed, is vertically inverted. The left and right side walls of the drug holder 14 are pressed inwardly to release the restraint member 36 out of engagement with the drug holder 14. The drug container 12 is released (drops) from the drug holder 14 together with the restraint member 36.

According to the third embodiment, as described above, the needle point angles of the first puncture needle 206 and the second puncture needle 208, and the elastic characteristics of the first plug 26 and the second plug 30 are established, such that when the first plug 26 is pressed by the first puncture needle 206 and the second plug 30 is pressed by the second puncture needle 208, the opening of the lumen 210 in the first puncture needle 206 is sealed by the first plug 26, and the opening in the lumen 210 of the second puncture needle 208 is sealed by the second plug 30. When the double-ended needle 204 pierces the first plug 26 and the second plug 30, the first plug 26, which is pressed by the first puncture needle 206, and the second plug 30, which is pressed by the second puncture needle 208, are initially elastically deformed, so that the openings of the lumens 210 of the first puncture needle 206 and the second puncture needle 208 become sealed by the first plug 26 and the second plug 30. Thereafter, the first puncture needle 206 and the second puncture needle 208 penetrate the first plug 26 and the second plug 30, respectively.

Since the needle point angles of the first puncture needle 206 and the second puncture needle 208, and the elastic characteristics of the first plug 26 and the second plug 30 are established as described above, openings in opposite ends of the lumen 210 are simultaneously sealed before the first puncture needle 206 and the second puncture needle 208 actually penetrate the first plug 26 and the second plug 30, respectively.

Therefore, even if the timing at which the first puncture needle 206 penetrates the first plug 26 differs from the timing at which the second puncture needle 208 penetrates the second plug 30, negative pressure in the drug container 12 is maintained and liquid is prevented from leaking out. More specifically, even if the first puncture needle 206 penetrates the first plug 26 before the second puncture needle 208 penetrates the second plug 30, since the opening of the lumen 210 of the second puncture needle 208 is sealed by the second plug 30, negative pressure in the drug container 12 is maintained. Further, even if the second puncture needle 208 penetrates the second plug 30 before the first puncture needle 206 penetrates the first plug 26, since the opening of the lumen 210 of the first puncture needle 206 is sealed by the first plug 26, liquid is prevented from leaking out.

According to the present invention, therefore, even if the timing at which the first puncture needle 206 penetrates the first plug 26 of the drug container 12 differs from the timing at which the second puncture needle 208 penetrates the second plug 30 of the liquid container 16, negative pressure in the drug container 12 is maintained and liquid is prevented from leaking out. Accordingly, a mixing instrument 200 is provided, which can be handled easily without causing handling errors.

According to the third embodiment, each of the respective cutting faces 212, 214 of the first puncture needle 206 and the second puncture needle 208 is formed as a curved concave surface, and the point of intersection between a line segment, which extends between the proximal end portion and the distal end portion of each of the cutting faces 212, 214, and the line normal to the line segment, which extends from the deepest point on the concave surface, is positioned closer to the proximal end portion of the cutting face than the midpoint of the line segment. Also, the center of the lumen 210 is closer to the proximal end portion of the cutting face than the central line of each puncture needle. With this arrangement, when the distal ends of the first puncture needle 206 and the second puncture needle 208 bite into the first plug 26 and the second plug 30, the areas (chins) of the cutting faces 212, 214 near the proximal end portions thereof temporarily bear the first plug 26 and the second plug 30. Since the openings of the lumen 210 are positioned closer to the chins, the openings in the opposite ends of the lumen 210 are reliably and simultaneously sealed.

According to the third embodiment, when the drug holder 14, the connector 202, and the liquid holder 18 are fitted together, the drug holder 14, the connector 202, and the liquid holder 18 slide against each other and are guided for relative axial movement. Therefore, the first puncture needle 206 and the second puncture needle 208 can pierce the first plug 26 and the second plug 30, respectively, accurately and simply in the axial direction. Therefore, the mixing instrument 200 can be handled more easily.

According to the third embodiment, when the drug holder 14, the connector 202, and the liquid holder 18 are coupled together, they are locked by the lock mechanism 37 so that they can be handled in their entirety as the integrated mixing instrument 10. Consequently, it is easy to perform the process of shaking the mixing instrument 200 to accelerate mixing of the first component and the second component.

### Fourth Embodiment

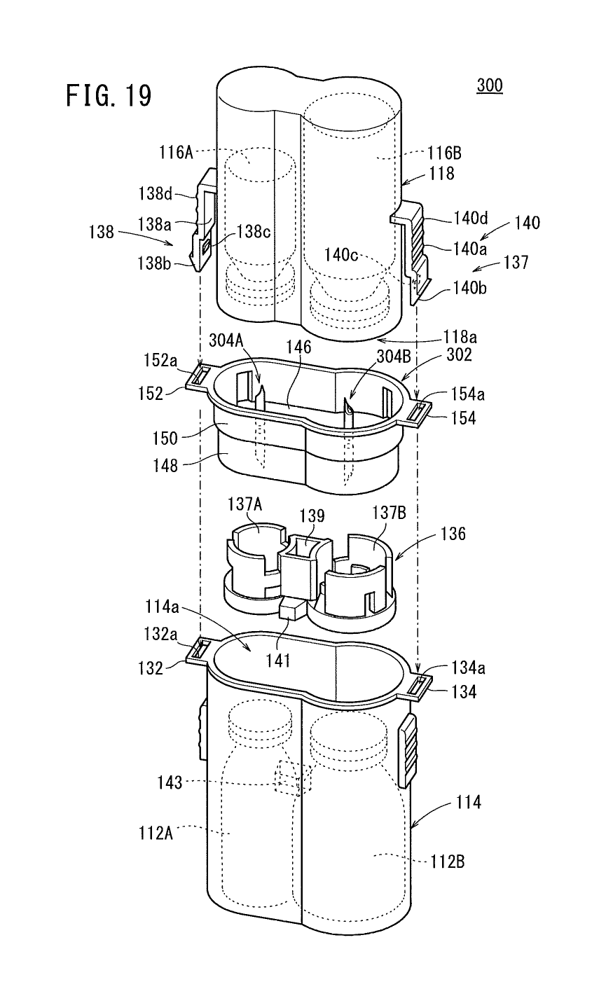

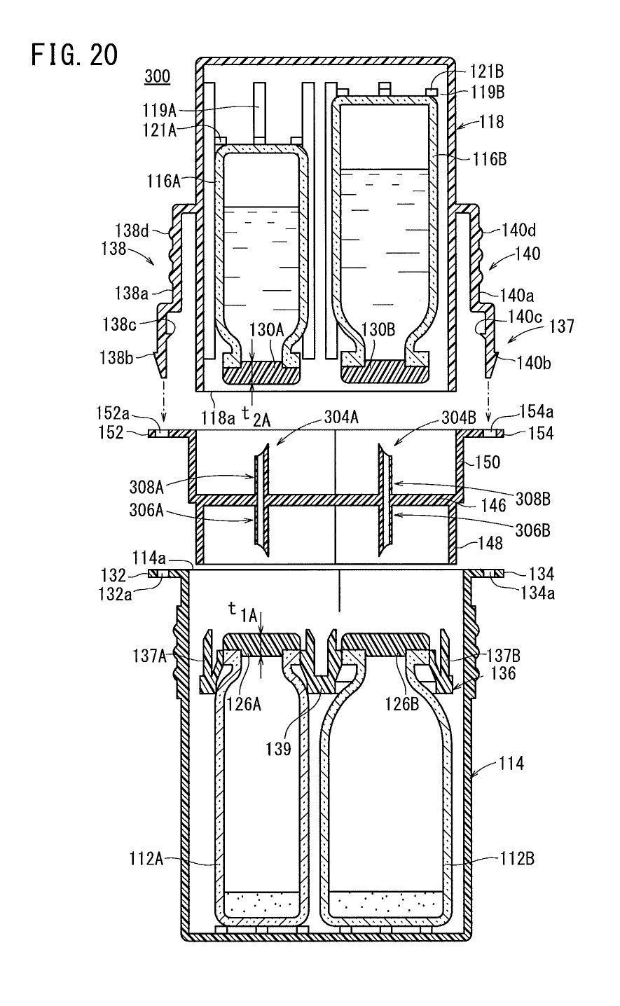

FIG. 19 is an exploded perspective view of a mixing instrument 300 according to a fourth embodiment of the present invention. FIG. 20 is a cross-sectional view of the mixing instrument 300 according to the fourth embodiment of the present invention. Components of the mixing instrument 300 according to the fourth embodiment, which have identical or similar functions and advantages to those of the mixing instrument 100 according to the second embodiment, are denoted by identical reference characters, and such features will not be described in detail below.

The mixing instrument 300 includes a connector 302, which is used in place of and differs in constitution from the connector 122 of the mixing instrument according to the second embodiment. The connector 302 has two integral double-ended needles 304A, 304B, which serve to bring the drug containers 112A, 112B and the liquid containers 116A, 116B into fluid communication with each other.

The mixing instrument 300 includes a lock mechanism 137, which is constitutively identical to the lock mechanism 137 of the mixing instrument 100. The lock mechanism 137 serves to releasably lock the drug holder 114, the connector 302, and the liquid holder 118 inseparably together when the drug holder 114, the connector 302, and the liquid holder 118 are fitted together in a relative positional relation, such that the first puncture needles 306A, 306B pierce the first plugs 126A, 126B and the second puncture needles 308A, 308B pierce the second plugs 130A, 130B.

According to a modification of the lock mechanism 137 shown in FIG. 19, lock members, which are similar to the lock members 138, 140, may be provided on the drug holder 114, and ledges, which are similar to the ledges 132, 134 for engaging the lock members, may be provided on the liquid holder 118.

As shown in FIGS. 19 and 20, the two double-ended needles 304A, 304B have respective first puncture needles 306A, 306B for piercing the first plugs 126A, 126B, respectively, and respective second puncture needles 308A, 308B for piercing the second plugs 130A, 130B, respectively. The two double-ended needles 304A, 304B are joined together integrally through the connector 302.

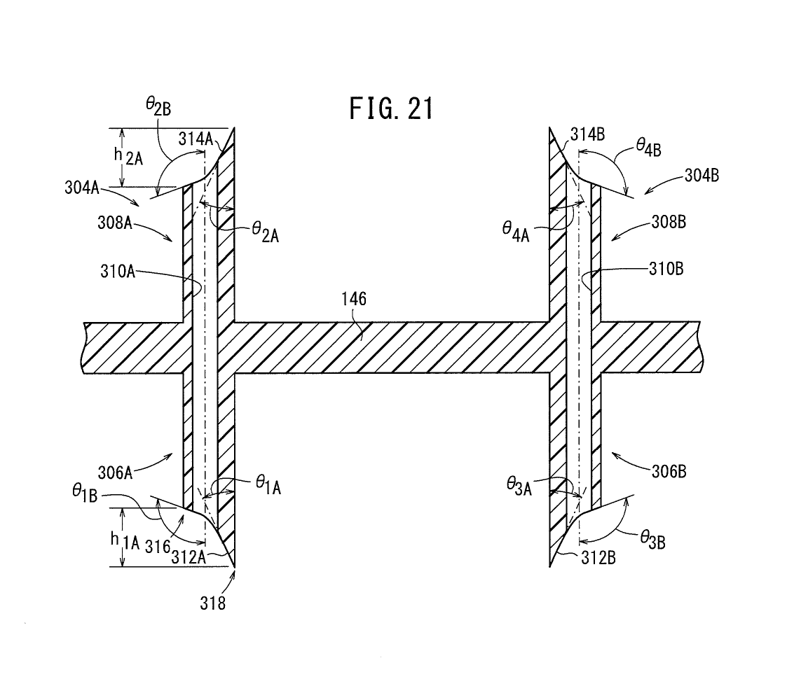

FIG. 21 is an enlarged cross-sectional view, partially omitted from illustration, showing the pair of double-ended needles 304A, 304B and nearby parts. The double-ended needles 304A, 304B have respective lumens (bores) 310A, 310B extending longitudinally (axially) therethrough, and which are open at opposite ends thereof. One of the openings of the lumens 310A, 310B opens into the cutting faces 312A, 312B of the first puncture needles 306A, 306B, whereas the other opening opens into the cutting faces 314A, 314B of the second puncture needles 308A, 308B.

Respective needle point angles θ1A, θ1B, θ2A, θ2B of the first puncture needles 306A, 306B and the second puncture needles 308A, 308B, and respective elastic characteristics of the first plugs 126A, 126B and the second plugs 130A, 130B are established, such that when the first plugs 126A, 126B are pressed by the first puncture needles 306A, 306B and the second plugs 130A, 130B are pressed by the second puncture needles 308A, 308B, the openings in opposite ends of the lumens 310A, 310B of the double-ended needles 304A, 304B are sealed by the first plugs 126A, 126B and the second plugs 130A, 130B, respectively.

The first puncture needles 306A, 306B and the second puncture needles 308A, 308B may be made of materials, which are the same as the aforementioned materials of the drug containers 112A, 112B.

The first puncture needles 306A, 306B and the partition 146 may be formed integrally with each other, or alternatively, may be separate members, which are secured together by adhesive bonding, welding, or the like. Similarly, the second puncture needles 308A, 308B and the partition 146 may be formed integrally with each other, or alternatively, may be separate members, which are secured together by adhesive bonding, welding, or the like. For example, the first puncture needles 306A, 306B and the second puncture needles 308A, 308B may be made of metal, preferably SUS, whereas the connector 302 itself may be integrally molded from a resin material.

According to the third embodiment, as shown in FIG. 21, the first puncture needles 306A, 306B and the second puncture needles 308A, 308B have respective cutting faces 312A, 312B, 314A, 314B, which are shaped as concave surfaces and are curved as viewed in vertical cross section.

In one of the double-ended needles 304A, the cutting face 312A of the first puncture needle 306A and the cutting face 314A of the second puncture needle 308A face in the same direction (i.e., the leftward direction shown in FIG. 20), in a direction perpendicular to the axial direction. In the other double-ended needle 304B, the cutting face 312B of the first puncture needle 306B and the cutting face 314B of the second puncture needle 308B face in the same direction (i.e., the rightward direction shown in FIG. 21), in a direction perpendicular to the axial direction. The double-ended needle 304A and the double-ended needle 304B face away from each other in respective directions in which the double-ended needle 304A and the double-ended needle 304B are spaced from each other (i.e., in leftward and rightward directions as shown in FIG. 20).

According to a modification of the fourth embodiment, the double-ended needles 304A, 304B shown in FIG. 21 may be inverted 180° about central axes thereof. More specifically, the cutting face 312A of the first puncture needle 306A and the cutting face 312B of the first puncture needle 306B may face toward each other, and the cutting face 314A of the second puncture needle 308A and the cutting face 314B of the second puncture needle 308B may face toward each other.

As shown in FIG. 21, in the double-ended needle 304A, the height h1A in the axial direction of the cutting face 312A of the first puncture needle 306A is smaller than the thickness t1A (see FIG. 20) of the portion of the first plug 126A that is pierced by the first puncture needle 306A. Further, the height h12 in the axial direction of the cutting face 314A of the second puncture needle 308A is smaller than the thickness t2A (see FIG. 20) of the portion of the second plug 130A that is pierced by the second puncture needle 308A. The thicknesses t1A, t2A of the first plug 126A and the second plug 130A should preferably be in the range from 1 to 4 mm, and more preferably, in the range from 2.0 to 2.5 mm.

In the other double-ended needle 304B, the relationship between the height in the axial direction of the cutting face 312B of the first puncture needle 306B and the thickness of the portion of the first plug 126B that is pierced by the first puncture needle 306B, and the relationship between the height in the axial direction of the cutting face 314B of the second puncture needle 308B and the thickness of the portion of the second plug 130B that is pierced by the second puncture needle 308B are the same as in the double-ended needle 304A.

According to the fourth embodiment, as with the third embodiment (see FIG. 4), the point of intersection between the line segment that extends between the distal end portion 318 of the cutting face 312A and the proximal end portion 316 thereof, and the line normal to the line segment, which extends from the deepest point on the concave surface (cutting face), is positioned closer to the proximal end portion of the cutting face than the midpoint of the line segment. Also, the center of the lumen 310A is closer to the proximal end portion 316 of the cutting face 312A than the central line of the puncture needle. In other words, the cutting face (concave surface) 312A is more deeply concave near the proximal end portion 316 of the cutting face 312A than near the distal end portion 318 thereof. The first puncture needle 306B and the second puncture needle 308B of the double-ended needle 304B are similar in shape to the first puncture needle 306A of the double-ended needle 304A.

The connector 302 has a partition 146 extending horizontally, a lower side wall 148 extending downwardly from the partition 146, and an upper side wall 150 extending upwardly from the partition 146. The two first puncture needles 306A, 306B are mounted on the lower surface of the partition 146, whereas the two second puncture needles 308A, 308B are mounted on the upper surface of the partition 146. The connector 302 may be made of materials, which are the same as the aforementioned materials of the drug holder 114.

The lower side wall 148 surrounds the first puncture needles 306A, 306B in their entirety. The lower side wall 148 has a height (vertical dimension), which is greater than the height of the first puncture needles 306A, 306B, so that the distal ends (cutting faces) of the two first puncture needles 306A, 306B do not project downwardly from the lower end of the lower side wall 148.

The upper side wall 150 surrounds the second puncture needles 308A, 308B in their entirety. The upper side wall 150 has a height (vertical dimension), which is greater than the height of the second puncture needles 308A, 308B, so that the distal ends (cutting faces) of the two second puncture needles 308A, 308B do not project upwardly from the upper side wall 150. The upper side wall 150 has ledges 152, 154 projecting horizontally outwardly from the left and right sides of the upper end thereof. The ledges 152, 154 have respective holes 152a, 154a formed vertically therethrough.

The connector 302 can be inserted into the drug holder 114, with the outer circumferential surface of the upper side wall 150 thereof serving as a sliding surface. More specifically, the connector 302 can move longitudinally (vertically) along the double-ended needles 304A, 304B with respect to the drug holder 114.

The liquid holder 118 can be inserted into the inside of the upper side wall 150 of the connector 302, with the outer circumferential surface of the lower end portion thereof serving as a sliding surface. More specifically, the liquid holder 118 can move longitudinally along the double-ended needles 304A, 304B with respect to the connector 302.

The mixing instrument 300 according to the fourth embodiment is basically constituted as described above. Operations and advantages of the mixing instrument 300 will be described below.

As shown in FIG. 20, the drug containers 112A, 112B are stored in the drug holder 114 and secured to the drug holder 114 by the restraint member 136. The liquid containers 116A, 116B are mounted in the liquid holder 118 and held by the liquid holder 118.

Then, the connector 302, with the two double-ended needles 304A, 304B installed therein, is inserted into the drug holder 114, such that the two first puncture needles 306A, 306B are oriented toward the drug containers 112A, 112B. Further, the liquid holder 118, with the two liquid containers 116A, 116B mounted therein, is inserted into the connector 302, such that the second plugs 130A, 130B are oriented toward the second puncture needles 308A, 308B.

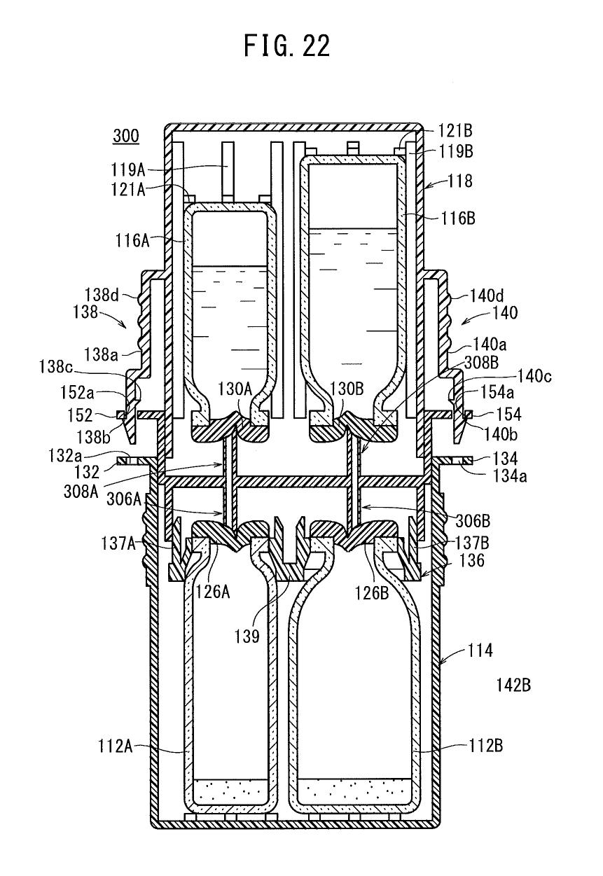

During the insertion process, as shown in FIG. 22, the first puncture needles 306A, 306B are pressed against the first plugs 126A, 126B, and the second puncture needles 308A, 308B are pressed against the second plugs 130A, 130B. Thus, the first plugs 126A, 126B and the second plugs 130A, 130B are elastically deformed. At this time, the first plugs 126A, 126B and the second plugs 130A, 130B are elastically deformed significantly, as with the first plug 26 (see FIG. 17) according to the third embodiment.

As described above, respective needle point angles θ1A, θ2A, θ3A, θ4A of the first puncture needles 306A, 306B and the second puncture needles 308A, 308B, and respective elastic characteristics of the first plugs 126A, 126B and the second plugs 130A, 130B are established, such that when the first puncture needles 306A, 306B are pressed against the first plugs 126A, 126B and the second puncture needles 308A, 308B are pressed against the second plugs 130A, 130B, openings in opposite ends of the lumens 310A, 310B of the double-ended needles 304A, 304B are sealed by the first plugs 126A, 126B and the second plugs 130A, 130B, respectively. In the illustrated embodiment, θ1A to θ4A are set to 30°, and θ1B to θ4B are set to 130°.

When the pair of double-ended needles 304A, 304B pierce the first plugs 126A, 126B and the second plugs 130A, 130B, the first plugs 126A, 126B, which are pressed by the first puncture needles 306A, 306B, and the second plugs 130A, 130B, which are pressed by the second puncture needles 308A, 308B, are elastically deformed initially, so that the first plugs 126A, 126B are held in close contact with the cutting faces 312A, 312B of the first puncture needles 306A, 306B, and the second plugs 130A, 130B are held in close contact with the cutting faces 314A, 314B of the second puncture needles 308A, 308B. As a result, openings in opposite ends of the lumens 310A, 310B are sealed respectively by the first plugs 126A, 126B and the second plugs 130A, 130B.

With the double-ended needles of the background art, the needle point angles are relatively small in order to reduce the resistance that the double-ended needles undergo when they penetrate the plugs. Therefore, the double-ended needles can penetrate the plugs easily. According to the double-ended needles of the background art, consequently, openings in opposite ends of the lumen cannot be simultaneously sealed by the plugs.

According to the fourth embodiment of the present invention, the needle point angles of the first puncture needles 306A, 306B and the second puncture needles 308A, 308B are greater than those in the double-ended needles of the background art, thereby intentionally lowering the forces with which the first puncture needles 306A, 306B and the second puncture needles 308A, 308B penetrate (pierce) the first plugs 126A, 126B and the second plugs 130A, 130B. Therefore, the first plugs 126A, 126B and the second plugs 130A, 130B are elastically deformed significantly, so as to seal the openings in the opposite ends of the lumens.

Whether or not the openings in the opposite ends of the lumens 310A, 310B can be sealed by the first plugs 126A, 126B and the second plugs 130A, 130B is determined by the forces applied by the first puncture needles 306A, 306B and the second puncture needles 308A, 308B to penetrate the first plugs 126A, 126B and the second plugs 130A, 130B (i.e., the sharpness of the needle points), together with elastic characteristics, such as hardness and elongation characteristics, of the first plugs 126A, 126B and the second plugs 130A, 130B. Therefore, the needle point angles of the first puncture needles 306A, 306B and the second puncture needles 308A, 308B are established in view of the elastic characteristics of the first plugs 126A, 126B and the second plugs 130A, 130B.

According to the fourth embodiment, the proximal end areas of the cutting faces 312A, 312B, 314A, 314B, which are formed as concave surfaces, of the first puncture needles 306A, 306B and the second puncture needles 308A, 308B function as chins. Since such chins increase the penetration resistance with which the first plugs 126A, 126B and the second plugs 130A, 130B are penetrated when the distal ends of the first puncture needles 306A, 306B and the second puncture needles 308A, 308B bite into the first plugs 126A, 126B and the second plugs 130A, 130B, the chins temporarily bear the first plugs 126A, 126B and the second plugs 130A, 130B. Since the openings of the lumens 310A, 310B are positioned closer to the proximal end portions (the chins) of the cutting faces than the central lines of the double-ended needles 304A, 304B, while the chins bear the first plugs 126A, 126B and the second plugs 130A, 130B, the openings in the opposite ends of the lumens are simultaneously sealed by the first plugs 126A, 126B and the second plugs 130A, 130B.

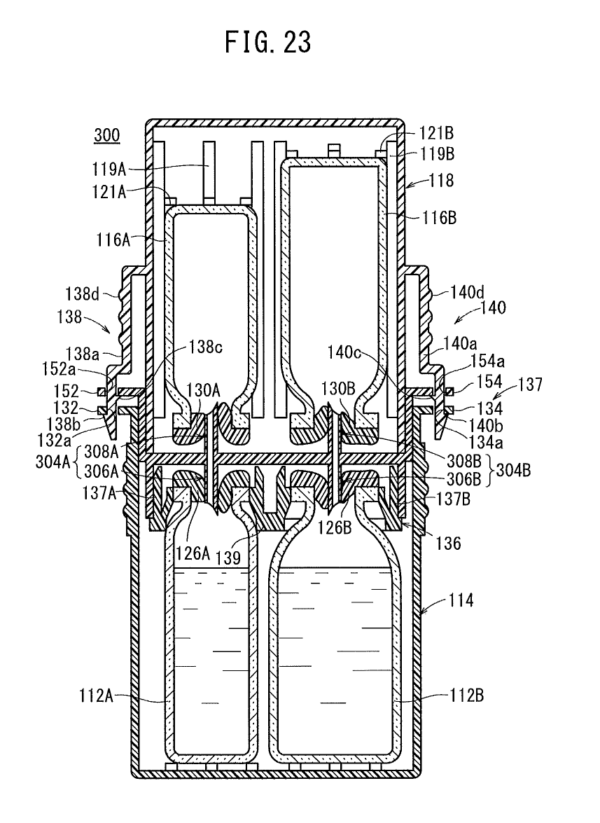

When the liquid holder 118 is further pushed toward the drug holders 114 from the state shown in FIG. 22, the mixing instrument 300 is assembled together, as shown in FIG. 23. The lock mechanism 137 is easily brought into the first state, as described above. More specifically, the first engaging portions 138b, 140b of the arms 138a, 140a engage with the respective ledges 132, 134 of the drug holder 114, and the second engaging portions 138c, 140c of the arms 138a, 140a engage the respective ledges 152, 154 of the connector 302. The lock mechanism 137 thus operates to limit the mutual positional relation between the drug containers 112A, 112B and the liquid containers 116A, 116B, i.e., to prevent the containers 112A, 112B, 116A, 116B from unduly moving, thereby reliably maintaining the drug containers 112A, 112B and the liquid containers 116A, 116B in fluid communication with each other.

When the liquid holder 118 is further pushed toward the drug holder 114 from the state shown in FIG. 22, the distance at which the first puncture needles 306A, 306B bite into the first plugs 126A, 126B increases to a certain extent, and the first plugs 126A, 126B are no longer capable of withstanding the pressure from the first puncture needles 306A, 306B, which then pierce the first plugs 126A, 126B. Similarly, when the distance at which the second puncture needles 308A, 308B bite into the second plugs 130A, 130B increases to a certain extent, the second plugs 130A, 130B are no longer capable of withstanding the pressure from the second puncture needles 308A, 308B, which then pierce the second plugs 130A, 130B. The cutting faces of the first puncture needles 306A, 306B and the second puncture needles 308A, 308B move respectively into the drug containers 112A, 112B and the liquid containers 116A, 116B. At this time, the drug containers 112A, 112B and the liquid containers 116A, 116B are brought into fluid communication with each other through the double-ended needles 304A, 304B.

Inasmuch as a negative pressure is developed in the two drug containers 112A, 112B, the liquid in the liquid containers 116A, 116B is attracted to and flows into the drug containers 112A, 112B through the two double-ended needles 304A, 304B. Thereafter, the mixing instrument 300 is shaken several times. At this time, the drugs in the drug containers 112A, 112B become diluted and dissolved by the liquids, which have flowed into the drug containers 112A, 112B.

After mixing of the drugs and the liquids is completed, the arms 138a, 140a of the lock members 138, 140 on the liquid holder 118 are pressed inwardly toward the liquid holder 118. The first engaging portions 138b, 140b of the arms 138a, 140a disengage from the ledges 132, 134 of the drug holder 114, whereas the second engaging portions 138c, 140c of the arms 138a, 140a remain in engagement with the ledges 152, 154 of the connector 122. In other words, the lock mechanism 137 is brought into the second state.

Then, the liquid holder 118 is pulled upwardly. The liquid holder 118, which holds the liquid containers 116A, 116B therein, can be released (removed) from the drug holder 114 together with the connector 302. Since the projections 138d, 140d are disposed on the arms 138a, 140a, the user finds it easy to pull the liquid holder 118 due to the fact that the projections 138d, 140d function as a slip stop.

Then, the drug holder 114, from which the connector 302 has been removed, is vertically inverted. The left and right side walls of the drug holder 114 are pressed inwardly to cause the engaging protrusion 141 of the restraint member 136 to become disengaged from the engaging recess 143 of the drug holder 114. At this time, the drug containers 112A, 112B are released (drop) from the drug holder 114 together with the restraint member 136.

According to the fourth embodiment, as described above, the double-ended needle 304A and the double-ended needle 304B face away from each other in respective directions in which the double-ended needle 304A and the double-ended needle 304B are spaced from each other. Consequently, when the double-ended needles 304A, 304B pierce the first plugs 126A, 126B and the second plugs 130A, 130B, respectively, forces acting horizontally on the double-ended needles 304A, 304B cancel each other out. Therefore, sliding resistance between the connector 302 and the drug holder 114 is prevented from increasing at the time that the connector 302 is inserted into the drug holder 114.

Further, according to the fourth embodiment, as described above, the needle point angles of the first puncture needles 306A, 306B and the second puncture needles 308A, 308B, and elastic characteristics of the first plugs 126A, 126B and the second plugs 130A, 130B are established, such that when the first plugs 126A, 126B are pressed against the first puncture needles 306A, 306B, and the second plugs 130A, 130B are pressed against the second puncture needles 308A, 308B, the openings of the lumens 310A, 310B of the first puncture needles 306A, 306B are sealed by the first plugs 126A, 126B, respectively, and the openings of the lumens 310A, 310B of the second puncture needles 308A, 308B are sealed by the second plugs 130A, 130B, respectively. When the double-ended needles 304A, 304B pierce the first plugs 126A, 126B and the second plugs 130A, 130B, the first plugs 126A, 126B, which are pressed by the first puncture needles 306A, 306B, and the second plugs 130A, 130B, which are pressed by the second puncture needles 308A, 308B, are elastically deformed initially, so that the openings of the lumens 310A, 310B of the first puncture needles 306A, 306B and the second puncture needles 308A, 308B are sealed respectively by the first plugs 126A, 126B and the second plugs 130A, 130B. Thereafter, the first puncture needles 306A, 306B and the second puncture needles 308A, 308B pierce the first plug 26 and the second plugs 130A, 130B, respectively. In other words, the openings at opposite ends of the lumens 310A, 310B are simultaneously sealed before the first puncture needles 306A, 306B and the second puncture needles 308A, 308B penetrate through the first plugs 126A, 126B and the second plugs 130A, 130B, respectively.

Consequently, even if the first puncture needles 306A, 306B penetrate the first plugs 126A, 126B before the second puncture needles 308A, 308B have penetrated the second plugs 130A, 130B, since the openings of the lumens of the second puncture needles 308A, 308B are sealed by the second plugs 130A, 130B, negative pressure in the drug containers 112A, 112B can be maintained. Further, even if the second puncture needles 308A, 308B penetrate the second plugs 130A, 130B before the first puncture needles 306A, 306B have penetrated the first plugs 126A, 126B, since the openings of the lumens of the first puncture needles 306A, 306B are sealed by the first plugs 126A, 126B, liquids are prevented from leaking out.

Consequently, negative pressure in the drug containers 112A, 112B is maintained, and the first components are prevented from leaking out, even if the timing at which the first puncture needles 306A, 306B penetrate the first plugs 126A, 126B differs from the timing at which the second puncture needles 308A, 308B penetrate the second plugs 130A, 130B. Accordingly, a mixing instrument 300 is provided, which can be handled easily without causing handling errors.

According to the fourth embodiment, the cutting faces of the first puncture needles 306A, 306B and the second puncture needles 308A, 308B are formed as concave surfaces, and the point of intersection between a line segment that extends between the proximal end portion of each of the cutting faces and the distal end portion thereof, and the line normal to the line segment, which extends from the deepest point on the concave surface, is positioned closer to the proximal end portion of the cutting face than the midpoint of the line segment. Also, the center of the lumen is closer to the proximal end portion of the cutting face than the central line of each puncture needle. With this arrangement, when the distal ends of the first puncture needles 306A, 306B and the second puncture needles 308A, 308B bite into the first plugs 126A, 126B and the second plugs 130A, 130B, the proximal end areas (i.e., chins) of the cutting faces temporarily bear the first plugs 126A, 126B and the second plugs 130A, 130B. Since the openings at the opposite ends of the lumens 310A, 310B are positioned closer to the chins, the openings at the opposite ends of the lumens 310A, 310B are reliably and simultaneously sealed.

According to the fourth embodiment, when the drug holder 114, the connector 302, and the liquid holder 118 are fitted together, the components slide against each other and are guided for relative axial movement. Therefore, the first puncture needles 306A, 306B and the second puncture needles 308A, 308B are capable of piercing the first plugs 126A, 126B and the second plugs 130A, 130B, respectively, accurately and simply in the axial direction. Therefore, the mixing instrument 300 can be handled more easily.

According to the fourth embodiment, when the drug holder 114, the connector 302, and the liquid holder 118 are coupled together, the drug holder 114, the connector 302, and the liquid holder 118 become locked by the lock mechanism 37, so that they can be handled in their entirety as an integrated mixing instrument 300. Consequently, it is easy to perform the process of shaking the mixing instrument 300 in order to accelerate mixing of the first component and the second component.

The present invention is not limited to the above arrangements, but various other arrangements may be adopted based on the content of the present description.

1. A mixing instrument for mixing a first component and a second component with each other, comprising:
a first container for storing the first component, the first container having a mouth sealed by a first plug made of an elastic material and having a negative pressure developed therein;
a second container for storing the second component, the second container having a mouth sealed by a second plug made of an elastic material; and
a double-ended needle having a first puncture needle for piercing the first plug and a second puncture needle for piercing the second plug, wherein the double-ended needle brings the first container and the second container into fluid communication with each other when the first puncture needle pierces the first plug and the second puncture needle pierces the second plug,
wherein the first puncture needle and the second puncture needle include respective increased penetration resistance members disposed at positions closer to proximal end portions than distal-end tubes thereof including cutting faces, and having a greater penetration resistance to the first plug and the second plug than the distal-end tubes, and
wherein the cutting faces of the distal-end tubes have respective heights in an axial direction which are smaller than thicknesses of the first plug and the second plug.

2. The mixing instrument according to claim 1, wherein the increased penetration resistance members comprise increased diameter members having outside diameters greater than the outside diameters of the distal-end tubes.

3. The mixing instrument according to claim 2, wherein the first puncture needle and the second puncture needle have respective inner tubes made of metal and including the distal-end tubes and respective outer tubes surrounding the inner tubes that serve as the increased penetration resistance members.

4. The mixing instrument according to claim 1, further comprising:
a first holder shaped as a hollow tube having a first opening formed in an end thereof, the first container being mounted in the first holder;
a second holder shaped as a hollow tube having a second opening formed in an end thereof, the second container being mounted in the second holder; and
a connector, the double-ended needle being mounted on the connector, the connector being slidable in an axial direction of the double-ended needle into fitting engagement with the end of the first holder with the first opening formed therein, and being slidable in an axial direction of the double-ended needle into fitting engagement with the end of the second holder with the second opening formed therein.

5. The mixing instrument according to claim 4, further comprising:
a lock mechanism for releasably locking the first holder, the connector, and the second holder inseparably together when the first holder, the connector, and the second holder are fitted together in a relative positional relation, such that the first puncture needle pierces the first plug and the second puncture needle pierces the second plug.

6. The mixing instrument according to claim 4, wherein the first container, the second container, and the double-ended needle each are provided in two sets;
two first containers are mounted in the first holder;
two second containers are mounted in the second holder;
paired double-ended needles are mounted on the connector and spaced from each other in directions perpendicular to the axial direction; and
one of the double-ended needles and the other double-ended needle have respective cutting faces facing away from each other in directions in which the double-ended needles are spaced from each other.

7. A piercing method for causing a double-ended needle, having a first puncture needle on one end and a second puncture needle on another end thereof, to pierce a first plug made of an elastic material and sealing a mouth of a first container and a second plug made of an elastic material and sealing a mouth of a second container having a negative pressure developed therein, thereby bringing the first container and the second container into fluid communication with each other, comprising the steps of:
preparing the double-ended needle having the first puncture needle and the second puncture needle which include respective increased penetration resistance members disposed at positions closer to proximal end portions than distal-end tubes thereof including cutting faces, and having a greater penetration resistance to the first plug and the second plug than the distal-end tubes;
sealing both ends by pressing a distal end of the first puncture needle into the first plug to close a first opening formed in the distal end of the first puncture needle with the first plug while temporarily preventing a distance by which the first puncture needle is inserted into the first plug from increasing with the increased penetration resistance member of the first puncture needle, and pressing a distal end of the second puncture needle into the second plug to close a second opening formed in the distal end of the second puncture needle while temporarily preventing a distance by which the second puncture needle is inserted into the second plug from increasing with the increased penetration resistance member of the second puncture needle; and
after sealing the both ends, piercing the first plug with the first puncture needle and piercing the second plug with the second puncture needle to thereby bring the first container and the second container into fluid communication with each other.

8. A mixing instrument for mixing a first component and a second component with each other, comprising:
a first container for storing the first component, the first container being sealed by a first plug made of an elastic material and having a negative pressure developed therein;
a second container for storing the second component, the second container having a mouth sealed by a second plug made of an elastic material; and
a double-ended needle having a first puncture needle for piercing the first plug and a second puncture needle for piercing the second plug, wherein the double-ended needle brings the first container and the second container into fluid communication with each other when the first puncture needle pierces the first plug and the second puncture needle pierces the second plug,
wherein respective needle point angles of the first puncture needle and the second puncture needle and respective elastic characteristics of the first plug and the second plug are established, such that when the first puncture needle is pressed by the first plug and the second puncture needle is pressed by the second plug, openings formed in opposite ends of a lumen of the double-ended needle are sealed by the first plug and the second plug, respectively, and
wherein the first puncture needle and the second puncture needle have respective cutting faces having respective heights in an axial direction which are smaller than thicknesses of the first plug and the second plug.

9. The mixing instrument according to claim 8, wherein the cutting faces of the first puncture needle and the second puncture needle are shaped as concave surfaces, which are curved as viewed in vertical cross section, and a point of intersection between a line segment that extends between a proximal end portion of each of the cutting faces and a distal end portion thereof, and a line normal to the line segment that extends from a deepest point on the concave surface is positioned closer to the proximal end portion of the cutting face than the midpoint of the line segment, and a center of the lumen is closer to the proximal end portion of the cutting face than a central line of each puncture needle.

10. The mixing instrument according to claim 8, further comprising:
a first holder shaped as a hollow tube having a first opening formed in one end thereof, the first container being mounted in the first holder;
a second holder shaped as a hollow tube having a second opening formed in one end thereof, the second container being mounted in the second holder; and
a connector, the double-ended needle being mounted on the connector, the connector being slidable in an axial direction of the double-ended needle into fitting engagement with the end of the first holder with the first opening formed therein, and being slidable in an axial direction of the double-ended needle into fitting engagement with the end of the second holder with the second opening formed therein.

11. The mixing instrument according to claim 10, further comprising:
a lock mechanism for releasably locking the first holder, the connector, and the second holder inseparably together when the first holder, the connector, and the second holder are fitted together in a relative positional relation, such that the first puncture needle pierces the first plug and the second puncture needle pierces the second plug.

12. The mixing instrument according to claim 10, wherein the first container, the second container, and the double-ended needle each are provided in two sets;
two first containers are mounted in the first holder;
two second containers are mounted in the second holder;
the paired double-ended needles are mounted on the connector and spaced from each other in directions perpendicular to the axial direction; and
one of the double-ended needles and the other double-ended needle have the respective cutting faces facing away from each other in directions in which the double-ended needles are spaced from each other.

13. A piercing method for causing a double-ended needle, having a first puncture needle on one end and a second puncture needle on another end thereof, to pierce a first plug made of an elastic material and sealing a mouth of a first container, and a second plug made of an elastic material and sealing a mouth of a second container having a negative pressure developed therein, thereby bringing the first container and the second container into fluid communication with each other, comprising the steps of:
preparing the double-ended needle, the first plug, and the second plug, wherein respective needle point angles of the first puncture needle and the second puncture needle and respective elastic characteristics of the first plug and the second plug are established, such that when the first puncture needle is pressed by the first plug and the second puncture needle is pressed by the second plug, openings formed in opposite ends of a lumen of the double-ended needle are sealed by the first plug and the second plug, respectively;
sealing both ends by pressing a distal end of the first puncture needle into the first plug to elastically deform the first plug and to close a first opening formed in the distal end of the first puncture needle with the first plug, and pressing a distal end of the second puncture needle into the second plug to elastically deform the second plug and to close a second opening formed in the distal end of the second puncture needle with the second plug; and
after sealing the both ends, piercing the first plug with the first puncture needle and piercing the second plug with the second puncture needle to thereby bring the first container and the second container into fluid communication with each other.
